(19) United States
(12) Patent Application Publication
(10) Pub. No.: US 2026/0006625 A1
(43) Pub. Date: Jan. 1, 2026

(54) METHOD AND APPARATUS FOR DETERMINING SIDELINK HYBRID AUTOMATIC REPEAT REQUEST ACKNOWLEDGEMENT (HARQ-ACK) FEEDBACK TRANSMISSION OCCASIONS

(71) Applicant: Lenovo (Beijing) Limited, Beijing (CN)

(72) Inventors: Haipeng Lei, Beijing (CN); Yu Zhang, Beijing (CN); Xiaodong Yu, Beijing (CN); Zhennian Sun, Beijing (CN)

(73) Assignee: Lenovo (Beijing) Limited, Beijing (CN)

(21) Appl. No.: 18/880,635

(22) PCT Filed: Jul. 18, 2022
(86) PCT No.: PCT/CN2022/106332

§ 371 Date: Jan. 2, 2025

(51) Int. Cl. H04W 72/25; H04L 1/1812; H04L 5/00; H04W 74/0808

(52) U.S. Cl. CPC H04W 72/25; H04L 5/0055; H04W 74/0808; H04L 1/1812

(57) ABSTRACT

Embodiments of the present disclosure relate to methods and apparatuses for determining sidelink HARQ-ACK feedback transmission occasions over unlicensed spectrums. According to some embodiments of the disclosure, a UE may: perform a first channel access procedure to initiate a first COT; determine a first PSFCH occasion inside of the first COT; determine whether there is HARQ-ACK feedback to be transmitted in the first PSFCH occasion; and in response to determining that there is HARQ-ACK feedback to be transmitted in the first PSFCH occasion, leave gap symbols for the first PSFCH occasion within the first COT blank, or in response to determining that no HARQ-ACK feedback is to be transmitted in the first PSFCH occasion, perform continuous transmissions in the first PSFCH occasion.

### TECHNICAL FIELD

Embodiments of the present disclosure generally relate to wireless communication technology, and more particularly to sidelink hybrid automatic repeat request acknowledgement (HARQ-ACK) feedback transmission occasion determination over unlicensed spectrums.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long-term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. The term “sidelink” may refer to a radio link established for communicating among devices (e.g., UEs), as opposed to communicating via the cellular infrastructure (e.g., uplink and downlink). Sidelink transmissions may be performed on a licensed spectrum and an unlicensed spectrum.

There is a need for handling sidelink transmissions on an unlicensed spectrum.

### SUMMARY

Some embodiments of the present disclosure provide a first user equipment (UE). The first UE may include a transceiver, and a processor coupled to the transceiver. The processor may be configured to: perform a first channel access procedure to initiate a first channel occupancy time (COT); determine a first physical sidelink feedback channel (PSFCH) occasion inside of the first COT; determine whether there is hybrid automatic repeat request acknowledgement (HARQ-ACK) feedback to be transmitted in the first PSFCH occasion; and in response to determining that there is HARQ-ACK feedback to be transmitted in the first PSFCH occasion, leave gap symbols for the first PSFCH occasion within the first COT blank, or in response to determining that no HARQ-ACK feedback is to be transmitted in the first PSFCH occasion, perform continuous transmissions in the first PSFCH occasion.

In some embodiments of the present disclosure, the first PSFCH occasion is determined based on a PSFCH periodicity with reference to a PSFCH resource pool.

In some embodiments of the present disclosure, determining there is HARQ-ACK feedback to be transmitted in the first PSFCH occasion may include: determining first HARQ-ACK feedback for a first PSSCH is to be transmitted in the first PSFCH occasion, wherein the first PSSCH is transmitted by the first UE; determining second HARQ-ACK feedback for a second PSSCH is to be transmitted in the first PSFCH occasion, wherein the second PSSCH is received by the first UE; and determining third HARQ-ACK feedback for a third PSSCH is to be transmitted in the first PSFCH occasion, wherein the third PSSCH is not transmitted or received by the first UE.

In some embodiments of the present disclosure, the processor may be further configured to: in response to being incapable of determining whether there is HARQ-ACK feedback to be transmitted in the first PSFCH occasion, perform energy detection or a second channel access procedure in the first PSFCH occasion, and perform continuous transmissions in remaining duration of the first PSFCH occasion in response to the detected energy being lower than a threshold or the second channel access procedure being successful.

In some embodiments of the present disclosure, the first PSFCH occasion is determined based on a PSFCH periodicity with reference to the first COT.

In some embodiments of the present disclosure, the processor may be further configured to: transmit a first PSSCH in the first COT to a second UE; and determine whether first HARQ-ACK feedback for the first PSSCH is to be transmitted in the first PSFCH occasion or outside of the first COT.

In some embodiments of the present disclosure, the processor may be further configured to: in response to determining that the first HARQ-ACK feedback for the first PSSCH is to be transmitted outside of the first COT, perform a third channel access procedure to initiate a second COT after the first COT, and transmit second SCI to request the second UE to transmit the first HARQ-ACK feedback in a second PSFCH occasion. The second PSFCH occasion is inside of the second COT and determined based on the PSFCH periodicity with reference to the second COT. In some embodiments of the present disclosure, the processor may be further configured to: determine to cancel the first PSFCH occasion in response to determining that the first HARQ-ACK feedback for the first PSSCH is to be transmitted outside of the first COT.

In some embodiments of the present disclosure, the processor may be further configured to perform continuous transmission in the first PSFCH occasion in response to determining to cancel the first PSFCH occasion.

In some embodiments of the present disclosure, the PSFCH periodicity is based on a CAPC used for performing the first channel access procedure. In some embodiments of the present disclosure, the PSFCH periodicity is based on a maximum duration of the first COT. In some embodiments of the present disclosure, the PSFCH periodicity is predefined or configured by RRC signaling.

In some embodiments of the present disclosure, the processor may be further configured to transmit, to a second UE, first SCI for scheduling a first PSSCH in the first COT. The first SCI includes a HARQ-ACK feedback timing indicator for the second UE to determine a PSFCH occasion for transmitting first HARQ-ACK feedback for the first PSSCH. The processor may be further configured determine whether the first HARQ-ACK feedback is to be transmitted in the first PSFCH occasion or outside of the first COT.

In some embodiments of the present disclosure, the HARQ-ACK feedback timing indicator indicates an offset between a first slot where the first PSSCH is transmitted and a second slot where the first HARQ-ACK feedback for the first PSSCH is transmitted.

In some embodiments of the present disclosure, the HARQ-ACK feedback timing indicator indicates the offset from a set of HARQ-ACK feedback timing values.

In some embodiments of the present disclosure, the first SCI indicates a channel access type for the second UE to transmit the first HARQ-ACK feedback.

In some embodiments of the present disclosure, the processor may be further configured to: in response to determining that the first HARQ-ACK feedback for the first PSSCH is to be transmitted outside of the first COT, set the HARQ-ACK feedback timing indicator in the first SCI to indicate an inapplicable HARQ-ACK feedback timing value (e.g., −1) or a reserved code point, perform a third channel access procedure to initiate a second COT after the first COT, and transmit second SCI in the second COT to request the second UE to transmit the first HARQ-ACK feedback in a second PSFCH occasion. The second PSFCH occasion is inside of the second COT and determined based on a HARQ-ACK feedback timing value indicated by a HARQ-ACK feedback timing indicator in the second SCI.

In some embodiments of the present disclosure, the processor may be further configured to: in response to determining that the first HARQ-ACK feedback for the first PSSCH is to be transmitted outside of the first COT, set the HARQ-ACK feedback timing indicator in the first SCI to indicate a HARQ-ACK feedback timing value for indicating a third PSFCH occasion for transmitting the first HARQ-ACK feedback. The third PSFCH occasion is outside of the first COT.

In some embodiments of the present disclosure, the processor may be further configured to: in response to determining that the first HARQ-ACK feedback for the first PSSCH is to be transmitted in the first PSFCH occasion, set the HARQ-ACK feedback timing indicator in the first SCI to indicate a HARQ-ACK feedback timing value for indicating the first PSFCH occasion for transmitting the first HARQ-ACK feedback.

In some embodiments of the present disclosure, the second SCI schedules a PSSCH in the second COT, and includes a HARQ-ACK feedback request indicator requesting the transmission of the first HARQ-ACK feedback in the second COT.

In some embodiments of the present disclosure, the second SCI schedules a PSSCH in the second COT, and includes a first HARQ process number field and a HARQ-ACK feedback request indicator requesting a transmission of HARQ-ACK feedback associated with a HARQ process number(s) indicated by the first HARQ process number field in the second COT. The HARQ process number(s) indicated by the first HARQ process number field includes a HARQ process number associated with the first HARQ-ACK feedback.

In some embodiments of the present disclosure, the second SCI schedules a PSSCH in the second COT, and includes a second HARQ process number field for requesting a transmission of HARQ-ACK feedback for a previous PSSCH(s) associated with a HARQ process number(s) indicated by the second HARQ process number field in the second COT. The HARQ process number(s) indicated by the second HARQ process number field includes a HARQ process number associated with the first HARQ-ACK feedback.

In some embodiments of the present disclosure, the second SCI is specific for requesting HARQ-ACK feedback, and the second SCI includes a third HARQ process number field indicating a HARQ process number associated with the first HARQ-ACK feedback.

In some embodiments of the present disclosure, the first, second or third HARQ process number field further indicates at least one of: a HARQ process number associated with HARQ-ACK feedback which cannot be transmitted in the first COT due to a channel access process failure, or a HARQ process number associated with HARQ-ACK feedback which is not correctly received by the first UE in the first COT.

In some embodiments of the present disclosure, in the case that the second HARQ process number field indicates a HARQ process number the same as a fourth HARQ process number field in the second SCI associated with the PSSCH scheduled by the second SCI, the second HARQ process number field does not request a transmission of any HARQ-ACK feedback.

In some embodiments of the present disclosure, the processor may be further configured to: receive the first HARQ-ACK feedback in the third PSFCH occasion; and in response to not receiving the first HARQ-ACK feedback in the third PSFCH occasion, perform a fourth channel access procedure to initiate a third COT after the third PSFCH occasion, and transmit third SCI in the third COT to request the second UE to transmit the first HARQ-ACK feedback in the third COT.

In some embodiments of the present disclosure, the processor may be further configured to: determine whether the first HARQ-ACK feedback for the first PSSCH is disabled; and perform at least one of the following in response to determining that the first HARQ-ACK feedback for the first PSSCH is disabled: set the HARQ-ACK feedback timing indicator in the first SCI to indicate an inapplicable HARQ-ACK feedback timing value (e.g., −2) or a reserved code point; or set a HARQ enabling/disabling indicator in the first SCI to disable HARQ-ACK feedback for the first PSSCH.

Some embodiments of the present disclosure provide a second UE. The second UE may include a transceiver, and a processor coupled to the transceiver. The processor may be configured to: receive, from a first UE, first sidelink control information (SCI) scheduling a first physical sidelink shared channels (PSSCH) within a first channel occupancy time (COT) initiated by the first UE; determine a first physical sidelink feedback channel (PSFCH) occasion inside of the first COT; determine whether first hybrid automatic repeat request acknowledgement (HARQ-ACK) feedback for the first PSSCH is to be transmitted in the first PSFCH occasion; and in response to determining that the first HARQ-ACK feedback is to be transmitted in the first PSFCH occasion, perform a first channel access procedure in a gap symbol for the first PSFCH occasion within the first COT, and transmit, to the first UE, the first HARQ-ACK feedback in the first PSFCH occasion in response to the first channel access procedure being successful.

In some embodiments of the present disclosure, the first PSFCH occasion is determined based on a PSFCH periodicity with reference to a PSFCH resource pool.

In some embodiments of the present disclosure, the first PSFCH occasion is determined based on a PSFCH periodicity with reference to the first COT.

In some embodiments of the present disclosure, the processor may be further configured to: in response to determining that the first HARQ-ACK feedback for the first PSSCH is to be transmitted outside of the first COT, postpone a transmission of the first HARQ-ACK feedback until receiving, from the first UE, a second SCI in a second COT initiated by the first UE for requesting the transmission of the first HARQ-ACK feedback in a second PSFCH occasion. The second PSFCH occasion is inside of the second COT and determined based on the PSFCH periodicity with reference to the second COT.

In some embodiments of the present disclosure, the PSFCH periodicity is based on a CAPC used for performing a channel access procedure to initiate the first COT. In some embodiments of the present disclosure, the PSFCH periodicity is based on a maximum duration of the first COT. In some embodiments of the present disclosure, the PSFCH periodicity is predefined or configured by RRC signaling.

In some embodiments of the present disclosure, the first SCI includes a HARQ-ACK feedback timing indicator for the second UE to determine a PSFCH occasion for transmitting the first HARQ-ACK feedback for the first PSSCH.

In some embodiments of the present disclosure, the HARQ-ACK feedback timing indicator indicates an offset between a first slot where the first PSSCH is transmitted and a second slot where the first HARQ-ACK feedback for the first PSSCH is transmitted.

In some embodiments of the present disclosure, the HARQ-ACK feedback timing indicator indicates the offset from a set of HARQ-ACK feedback timing values.

In some embodiments of the present disclosure, the first SCI indicates a channel access type for the second UE to transmit the first HARQ-ACK feedback.

In some embodiments of the present disclosure, the processor may be further configured to: in the case that the HARQ-ACK feedback timing indicator in the first SCI indicates an inapplicable HARQ-ACK feedback timing value (e.g., −1) or a reserved code point, postpone a transmission of the first HARQ-ACK feedback until receiving, from the first UE, a second SCI in a second COT initiated by the first UE for requesting the transmission of the first HARQ-ACK feedback in a second PSFCH occasion. The second PSFCH occasion is inside of the second COT and determined based on a HARQ-ACK feedback timing value indicated by a HARQ-ACK feedback timing indicator in the second SCI.

In some embodiments of the present disclosure, the processor may be further configured to: in the case that the HARQ-ACK feedback timing indicator in the first SCI indicates an applicable HARQ-ACK feedback timing value indicating a third PSFCH occasion outside of the first COT for transmitting the first HARQ-ACK feedback, transmit the first HARQ-ACK feedback in the third PSFCH occasion.

In some embodiments of the present disclosure, the processor may be further configured to: in the case that the HARQ-ACK feedback timing indicator in the first SCI indicates an applicable HARQ-ACK feedback timing value indicating the first PSFCH occasion for transmitting the first HARQ-ACK feedback, transmit the first HARQ-ACK feedback in the first PSFCH occasion.

In some embodiments of the present disclosure, the second SCI schedules a PSSCH in the second COT, and includes a HARQ-ACK feedback request indicator requesting the transmission of the first HARQ-ACK feedback in the second COT.

In some embodiments of the present disclosure, the second SCI schedules a PSSCH in the second COT, and includes a first HARQ process number field and a HARQ-ACK feedback request indicator requesting a transmission of HARQ-ACK feedback associated with a HARQ process number(s) indicated by the first HARQ process number field in the second COT. The HARQ process number(s) indicated by the first HARQ process number field includes a HARQ process number associated with the first HARQ-ACK feedback.

In some embodiments of the present disclosure, the second SCI schedules a PSSCH in the second COT, and includes a second HARQ process number field for requesting a transmission of HARQ-ACK feedback for a previous PSSCH(s) associated with a HARQ process number(s) indicated by the second HARQ process number field in the second COT. The HARQ process number(s) indicated by the second HARQ process number field includes a HARQ process number associated with the first HARQ-ACK feedback.

In some embodiments of the present disclosure, the second SCI is specific for requesting HARQ-ACK feedback, and the second SCI includes a third HARQ process number field indicating a HARQ process number associated with the first HARQ-ACK feedback.

In some embodiments of the present disclosure, the first, second or third HARQ process number field further indicates at least one of: a HARQ process number associated with HARQ-ACK feedback which cannot be transmitted in the first COT due to a channel access process failure, or a HARQ process number associated with HARQ-ACK feedback which is not correctly received by the first UE in the first COT.

In some embodiments of the present disclosure, in the case that the second HARQ process number field indicates a HARQ process number the same as a fourth HARQ process number field in the second SCI associated with the PSSCH scheduled by the second SCI, the second HARQ process number field does not request a transmission of any HARQ-ACK feedback.

In some embodiments of the present disclosure, the processor may be further configured to: perform a second channel access procedure for transmitting the first HARQ-ACK feedback in the third PSFCH occasion; in response to the second channel access procedure being successful, transmit the first HARQ-ACK feedback in the third PSFCH occasion; and in response to the second channel access procedure being unsuccessful, drop the third PSFCH occasion.

In some embodiments of the present disclosure, the processor may be further configured to: in response to the second channel access procedure being unsuccessful, receive, from the first UE, a third SCI in a third COT initiated by the first UE for requesting the transmission of the first HARQ-ACK feedback in the third COT.

In some embodiments of the present disclosure, in the case that the first HARQ-ACK feedback for the first PSSCH is disabled, the HARQ-ACK feedback timing indicator in the first SCI indicates an inapplicable HARQ-ACK feedback timing value (e.g., −2) or a reserved code point. In some embodiments of the present disclosure, in the case that the first HARQ-ACK feedback for the first PSSCH is disabled, a HARQ enabling/disabling indicator in the first SCI indicates that HARQ-ACK feedback for the first PSSCH is disabled.

Some embodiments of the present disclosure provide a method for wireless communication performed by a first UE. The method may include: performing a first channel access procedure to initiate a first channel occupancy time (COT); determining a first physical sidelink feedback channel (PSFCH) occasion inside of the first COT; determining whether there is hybrid automatic repeat request acknowledgement (HARQ-ACK) feedback to be transmitted in the first PSFCH occasion; and in response to determining that there is HARQ-ACK feedback to be transmitted in the first PSFCH occasion, leaving gap symbols for the first PSFCH occasion within the first COT blank, or in response to determining that no HARQ-ACK feedback is to be transmitted in the first PSFCH occasion, performing continuous transmissions in the first PSFCH occasion.

Some embodiments of the present disclosure provide a method for wireless communication performed by a second UE. The method may include: receiving, from a first UE, first sidelink control information (SCI) scheduling a first physical sidelink shared channels (PSSCH) within a first channel occupancy time (COT) initiated by the first UE; determining a first physical sidelink feedback channel (PSFCH) occasion inside of the first COT; determining whether first hybrid automatic repeat request acknowledgement (HARQ-ACK) feedback for the first PSSCH is to be transmitted in the first PSFCH occasion; and in response to determining that the first HARQ-ACK feedback is to be transmitted in the first PSFCH occasion, performing a first channel access procedure in a gap symbol for the first PSFCH occasion within the first COT, and transmitting, to the first UE, the first HARQ-ACK feedback in the first PSFCH occasion in response to the first channel access procedure being successful.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2-4 illustrate exemplary configurations for PSFCH occasions in accordance with some embodiments of the present disclosure;

FIGS. 5 and 6 illustrate flow charts of exemplary procedures of sidelink communications in accordance with some embodiments of the present disclosure; and

FIG. 7 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

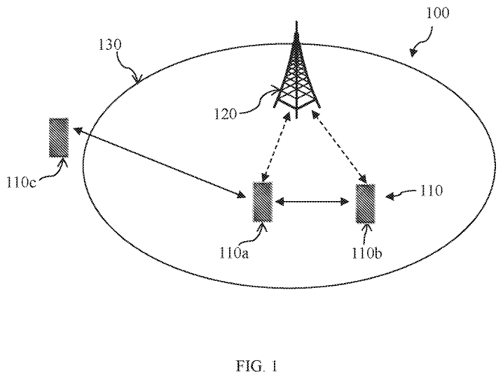

FIG. 1 illustrates a schematic diagram of a wireless communication system 100 in accordance with some embodiments of the present disclosure.

As shown in FIG. 1, wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1). In some embodiments, UE 110a, UE 110b, and UE 110c may form a UE group.

Sidelink transmissions may involve a physical sidelink control channel (PSCCH) and an associated physical sidelink shared channel (PSSCH), which are scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

The PSSCH may carry data which may require corresponding HARQ-ACK feedback from the Rx UE(s) to the Tx UE. For example, a broadcast transmission may not need HARQ-ACK feedback and a unicast or groupcast transmission may enable HARQ-ACK feedback under some preconditions. The HARQ-ACK feedback for a PSSCH may be carried on a physical sidelink feedback channel (PSFCH). In the context of the present disclosure, PSFCH and HARQ-ACK feedback may be used interchangeably.

In some embodiments of the present disclosure, a PSFCH may be transmitted within a PSFCH resource pool which may be periodically configured for the sidelink. For example, a UE can be indicated by an SCI format scheduling a PSSCH reception to transmit a PSFCH with HARQ-ACK information in response to the PSSCH reception. The UE may provide HARQ-ACK information that includes an acknowledgement (ACK) or a negative ACK (NACK), or only a NACK, depending on the HARQ-ACK feedback option employed. For example, a UE can be provided (e.g., by sl-PSFCH-Period as specified in 3GPP specifications) with a number of slots in a resource pool for a period of PSFCH transmission occasion resources. If the number is zero, PSFCH transmissions from the UE in the resource pool are disabled.

When a UE receives a PSSCH in a resource pool and the SCI associated with the PSSCH (e.g., the HARQ feedback enabled/disabled indicator field in the SCI) indicates that HARQ feedback is enabled (e.g., the HARQ feedback enabled/disabled indicator has a value of 1 in SCI format 2-A or SCI format 2-B), the UE may provide HARQ-ACK information in a PSFCH transmission in the resource pool. For example, the UE may transmit the PSFCH in the first (e.g., earliest) slot that includes a PSFCH resource(s) (e.g., PSFCH occasion(s)) and is at least a number of slots (e.g., provided by sl-MinTimeGapPSFCH as specified in 3GPP specifications) away from the last slot of the PSSCH reception in the resource pool.

In some embodiments of the present disclosure, sidelink transmissions may be performed on an unlicensed spectrum. This is advantageous because a sidelink transmission over an unlicensed spectrum can achieve, for example, an increased data rate(s). In order to achieve fair coexistence between various systems, for example, NR systems (e.g., NR-U systems) and other wireless systems, a channel access procedure, also known as a listen-before-talk (LBT) test, may be performed before communicating on the unlicensed spectrum.

Various types of channel access procedures including, but not limited to, channel access Type 1 and channel access Type 2 may be supported. In some examples, channel access Type 2 may further include channel access Type 2A, channel access Type 2B and channel access Type 2C. The specific definitions of channel access Type 1 and channel access Type 2 can be found in 3GPP specifications.

In some embodiments, by performing a channel access Type 1 procedure (also known as LBT Cat.4), a UE can obtain a channel occupancy (CO) and occupy the channel until the maximum channel occupancy time (MCOT). In some embodiments, the duration of the MCOT may be related to a channel access priority class (CAPC) value of the traffic priority and can be 2 ms, 4 ms, 6 ms, 8 ms or 10 ms, which is equivalent to 2, 4, 6, 8, or 10 slots in the case of 15 kHz subcarrier spacing (SCS), 4, 8, 12, 16, or 20 slots in the case of 30 kHz SCS, 8, 16, 24, 32, or 40 slots in the case of 60 kHz SCS, or 16, 32, 48, 64, or 80 slots in the case of 120 kHz SCS. Accordingly, after a UE performs a successful channel access Type 1 procedure, the UE can occupy the channel with a maximum of several or tens of slots, depending on the corresponding CAPC value and SCS.

In some embodiments of the present disclosure, the periodic PSFCH configuration may also be employed when the sidelink transmission is performed on an unlicensed spectrum. However, such configuration may have drawbacks. For example, when a UE initiates a COT by performing a channel access Type 1procedure, the COT may be frequently interrupted by the periodic PFSCH occasion. This is especially true since the PSFCH period is relatively small, i.e., 1, 2 or 4 slots.

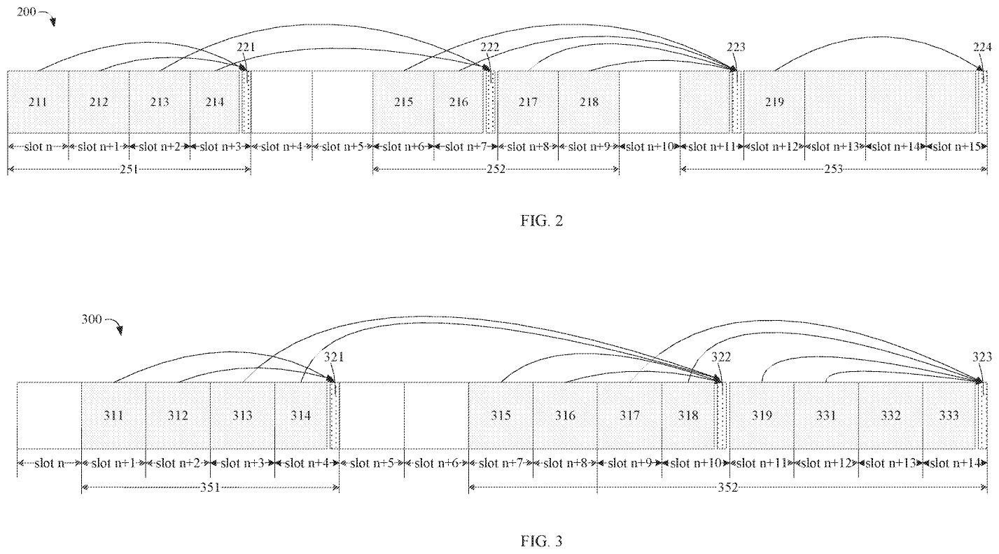

FIG. 2 shows exemplary periodic PFSCH configuration 200 in accordance with some embodiments of the present disclosure. In FIG. 2, the PSFCH periodicity is 4 slots. For example, slots n+3, n+7, n+11, and n+15 may include PFSCH occasions 221, 222, 223, and 224, respectively. A UE(s) may initiate COT 251, COT 252, and COT 253. COT 251 may be interrupted by PFSCH occasion 221. COT 252 may be interrupted by PFSCH occasion 222. COT 253 may be interrupted by PFSCH occasions 223 and 224. It should be noted that COTs 251-253 may be initiated by the same or different UEs.

In some examples, a UE which initiates COT 251 may transmit SCIs 211 and 212 in slot n and slot n+1, which schedule PSSCHs with corresponding HARQ-ACK feedback to be transmitted in PSFCH occasion 221. The UE may also transmit SCIs 213 and 214 in slot n+2 and slot n+3, which schedule PSSCHs with corresponding HARQ-ACK feedback to be transmitted in PSFCH occasion 222. Similarly, SCIs 215-218 transmitted in slot n+6-slot n+9 in COT 252 may schedule PSSCHs with corresponding HARQ-ACK feedback to be transmitted in PSFCH occasion 223. SCI 219 transmitted in slot n+12 in COT 253 may schedule a PSSCH with corresponding HARQ-ACK feedback to be transmitted in PSFCH occasion 224.

As shown in FIG. 2, even with a relatively large PSFCH periodicity, a COT may be interrupted frequently. When the COT has a duration of more than 4 slots, such as COT 253 in FIG. 2, it will be interrupted twice. This interruption brings, for example, the below drawbacks:
(1) A Tx UE cannot contiguously transmit sidelink transmissions in the time domain because the Tx UE needs to monitor the channel continuously and perform a channel access procedure (e.g., channel access Type 2) before it resumes its sidelink transmissions.
(2) A Tx UE is quite likely to lose the channel. When a gap is larger than a minimum sensing interval (e.g., 16 us or 25 us), there is a risk of losing the channel. When the COT is interrupted by a PSFCH occasion and there is no PSFCH transmitted during the occasion due to, for example, NACK-only based feedback or disabled HARQ-ACK feedback, the probability of losing the channel is quite high, considering, for example, one PSFCH occasion including gap symbols for the PSFCH occasion may occupy 4 consecutive symbols of about 280 us.
(3) For a PSFCH occasion within a UE's COT, when a PSFCH transmission in the PSFCH occasion is not targeted to the COT initiator UE, such PSFCH transmission may not be aligned with regulatory requirements.
(4) A channel access procedure (e.g., channel access Type 1) may have to be performed by an Rx UE for transmitting a PSFCH in a PSFCH occasion if the PSFCH is not inside of any COT. The Rx UE may initiate a COT only for transmitting the PSFCH. The channel access procedure may fail.
(5) When the PSFCH periodicity is relatively smaller (e.g., 1 or 2 slots), the current COT mechanism cannot work properly.

Embodiments of the present disclosure provide solutions for HARQ-ACK feedback transmissions on a sidelink over an unlicensed spectrum. The proposed solutions can at least solve the above-mentioned issues. More details on the embodiments of the present disclosure will be illustrated in the following text in combination with the appended drawings.

In some embodiments of the present disclosure, for sidelink transmissions over an unlicensed spectrum, PSFCH transmission occasions are determined based on a PSFCH periodicity with reference to a PSFCH resource pool. The PSFCH periodicity may be configured by radio resource control (RRC) signaling or predefined in a standard(s).

For a UE intending to transmit a PSFCH, a channel access procedure (e.g., channel access Type 2) is performed before transmitting the PSFCH in a PSFCH transmission occasion. A PSFCH transmission occasion is defined with reference to an initial slot of a PSFCH resource pool. For example, a slot may have a PSFCH transmission occasion resource if k mod N_{PSSCH}^{PSFCH}=0, where k denotes the slot index with reference to the initial slot of the PSFCH resource pool (e.g., k=0 pointing to the initial slot of the PSFCH resource pool), and N_{PSSCH}^{PSFCH} denotes the PSFCH periodicity. Based on such configuration, the PSFCH transmission occasions would not be dynamically changed in the time domain. In the context of the present disclosure, PSFCH transmission occasion and PSFCH occasion may be used interchangeably.

A Tx UE (denoted as UE #1 for simplicity) may initiate a COT by performing a channel access procedure (e.g., channel access Type 1). To address the above issues caused by the periodic PSFCH transmission occasions, UE #1 may determine whether there is a PSFCH transmission occasion inside of the COT and whether there is HARQ-ACK feedback (or at least one PSFCH) to be transmitted in the PSFCH transmission occasion inside of the COT, and then act accordingly based on the determination.

For example, in some embodiments, when UE #1 determines that a PSFCH transmission occasion is inside of the COT and further determines that there is HARQ-ACK feedback to be transmitted in the PSFCH transmission occasion (denoted as scenario #1), UE #1 may leave gap symbols for the PSFCH transmission occasion within the COT blank. For example, a symbol (e.g., one symbol) before the PSFCH transmission occasion may be left blank such that a UE can perform a channel access procedure (e.g., channel access Type 2) before transmitting a PSFCH in the PSFCH transmission occasion. For example, a symbol (e.g., one symbol) after the PSFCH transmission occasion may be left blank such that UE #1 can perform a channel access procedure (e.g., channel access Type 2) before resuming the transmission (e.g., in the next slot) in the COT. In some examples, when a PSFCH transmission occasion is located at the end of the COT, there may not be a gap symbol after the PSFCH transmission occasion.

In some embodiments, when UE #1 determines that a PSFCH transmission occasion is inside of the COT and further determines that there is no HARQ-ACK feedback (or no PSFCH) to be transmitted in the PSFCH transmission occasion (denoted as scenario #2), UE #1 may perform continuous transmissions in the PSFCH transmission occasion. For example, UE #1 may perform continuous transmissions in the PSFCH transmission occasion and a gap symbol(s) for the PSFCH transmission occasion within the COT. The gap symbol(s) for the PSFCH transmission occasion may include a symbol (e.g., one symbol) before the PSFCH transmission occasion, a symbol (e.g., one symbol) after the PSFCH transmission occasion, or both as described above. In this way, the risk of losing the channel can be avoided.

In some embodiments, when UE #1 determines that a PSFCH transmission occasion is inside of the COT, but cannot determine whether there is HARQ-ACK feedback to be transmitted in the PSFCH transmission occasion (e.g., whether a UE different from UE #1 may transmit a PSFCH in the PSFCH transmission occasion) (denoted as scenario #3), UE #1 may perform energy detection or a channel access procedure in the PSFCH transmission occasion (e.g., in the initial or first symbol of the PSFCH transmission occasion). In response to the detected energy being lower than a threshold or the channel access procedure being successful, which suggests that the channel is empty, UE #1 may perform continuous transmissions in the remaining duration of the PSFCH transmission occasion (e.g., in the second symbol of the PSFCH transmission occasion), to avoid the risk of losing the channel. UE #1 may also perform continuous transmissions in the symbol after the PSFCH transmission occasion.

In this way, the PSFCH transmission occasion can ensure a high LBT successful probability due to a channel access procedure (e.g., channel access Type 2) required. UE #1 can perform continuous transmissions to reserve the channel in the PSFCH transmission occasion (for simplicity, such transmission may also be referred as a reservation signal or a reservation transmission in the present disclosure) under certain cases including, for example, if it determines that no PSFCH will be transmitted in the PSFCH transmission occasion. Details regarding the reservation signal (or reservation transmission) will be described in detail in the following text. On the other hand, UE #1 may not transmit the reservation signal under certain cases including, for example, if it determines that a PSFCH will be transmitted in the PSFCH transmission occasion.

In some embodiments of the present disclosure, the following cases may be involved when UE #1 determines whether there is HARQ-ACK feedback or a PSFCH to be transmitted in a PSFCH transmission occasion within the COT initiated by UE #1. UE #1 may further determine whether or not to transmit the reservation signal in the PSFCH transmission occasion according to the following cases.

Case 1: UE #1 may determine whether it will transmit HARQ-ACK feedback or a PSFCH(s) for a PSSCH(s) received by UE #1 in the PSFCH transmission occasion in the COT. For example, UE #1 may receive a PSSCH in a slot, and may determine whether the HARQ-ACK feedback for the received PSSCH is to be transmitted by UE #1 in the PSFCH transmission occasion in the COT. Such determination can be made based on, for example, an associated HARQ-ACK enabled/disabled indicator and a cast type indicator in the SCI or PSCCH scheduling the PSSCH. The cast type indicator may indicate the HARQ-ACK feedback option for the PSSCH.

When UE #1 determines to transmit one or more PSFCHs in the PSFCH transmission occasion, UE #1 may transmit the one or more PSFCHs in the PSFCH transmission occasion. UE #1 may not transmit the reservation signal in the PSFCH transmission occasion.

For example, referring again to FIG. 2, in which the PSFCH transmission occasions may be configured by RRC signaling with a PSFCH periodicity of 4 slots, it is assumed that UE #1 initiates COT 252. Assuming that UE #1 receives PSSCHs in slots n+2 and n+3 and intends to transmit corresponding PSFCHs (e.g., HARQ-ACK feedback for the PSSCHs) in slot n+7, UE #1 may transmit the PSFCHs in slot n+7 and not transmit the reservation signal on the channel.

Case 2: UE #1 may determine whether it will receive HARQ-ACK feedback or a PSFCH for a PSSCH transmitted by UE #1 in the PSFCH transmission occasion in the COT. For example, UE #1 may transmit a PSSCH to another UE in a slot, and may determine whether the HARQ-ACK feedback for the transmitted PSSCH is to be received by UE #1 (i.e., to be transmitted by the another UE, which is an Rx UE of UE #1) in the PSFCH transmission occasion in the COT. Such determination can be made based on, for example, an associated HARQ-ACK enabled/disabled indicator and a cast type indicator in the SCI or PSCCH scheduling the PSSCH.

When UE #1 determines that it will receive one or more PSFCHs for the PSSCHs transmitted by UE #1 in the PSFCH transmission occasion, UE #1 may receive the one or more PSFCHs in the PSFCH transmission occasion. UE #1 may not transmit the reservation signal in the PSFCH transmission occasion.

For example, referring again to FIG. 2, in which the PSFCH transmission occasions may be configured by RRC signaling with a PSFCH periodicity of 4 slots, it is assumed that UE #1 initiates COTs 251 and 252. Assuming that UE #1 transmits PSSCHs in slots n+2 and n+3 and indicates the corresponding Rx UE(s) to transmit corresponding PSFCHs (e.g., HARQ-ACK feedback for the PSSCHs) in slot n+7. UE #1 may receive the PSFCHs in slot n+7 and not transmit the reservation signal on the channel.

Case 3: UE #1 may determine whether HARQ-ACK feedback or a PSFCH for a PSSCH, which is not transmitted or received by UE #1, will be transmitted in the PSFCH transmission occasion in the COT. For example, a Tx UE (e.g., UE #A) different from UE #1 may transmit a PSSCH to an Rx UE (e.g., UE #B) different from UE #1 in a slot. UE #1 may determine whether HARQ-ACK feedback for the PSSCH is to be transmitted by UE #B or received by UE #A in the PSFCH transmission occasion in the COT. Such determination can be made based on, for example, an associated HARQ-ACK enabled/disabled indicator and a cast type indicator in the SCI or PSCCH scheduling the PSSCH. For example, UE #1 can make the determination by decoding the SCI or PSCCH, which schedules the PSSCH transmitted by UE #A in a slot with corresponding HARQ-ACK feedback to be transmitted in the PSFCH transmission occasion.

When UE #1 determines that UE #B will transmit one or more PSFCHs in the PSFCH transmission occasion, UE #1 may not transmit the reservation signal in the PSFCH transmission occasion.

For example, referring again to FIG. 2, in which the PSFCH transmission occasions may be configured by RRC signaling with a PSFCH periodicity of 4 slots, it is assumed that UE #A initiates COT 251 and UE #1 initiates COT 252. Assuming that UE #A transmits PSSCHs to UE #B in slots n+2 and n+3, according to received PSCCHs in slots n+2 and n+3, which indicate UE #B to transmit corresponding PSFCHs in slot n+7. UE #1 may not transmit the reservation signal on the channel.

As mentioned above, in scenario #2, UE #1 may perform continuous transmissions in the PSFCH transmission occasion within the COT initiated by UE #1. The continuous transmissions can be implemented in various manners.

For example, in some embodiments of the present disclosure, UE #1 can continuously transmit an ongoing PSSCH in the PSFCH transmission occasion. For example, UE #1 can continuously transmit an ongoing PSSCH till the end of the slot where the PSFCH transmission occasion happens so as to fully occupy the slot. For example, the PSFCH transmission occasion and the gap symbol(s) for the PSFCH transmission occasion (if any) may be used by an ongoing PSSCH for sidelink transmission. The gap symbol(s) for the PSFCH transmission occasion may include a symbol (e.g., one symbol) before the PSFCH transmission occasion, a symbol (e.g., one symbol) after the PSFCH transmission occasion, or both as described above. In these embodiments, no symbol is wasted.

For example, referring again to FIG. 2, assuming that UE #1 initiates COT 252 and determines that scenario #2 happens, UE #1 may use PSFCH occasion 222 and the gap symbols before and after PSFCH occasion 222 to transmit a PSSCH. For example, a PSSCH may be transmitted from a location where it is scheduled in slot n+7 to the end of slot n+7.

In some embodiments of the present disclosure, UE #1 can continuously transmit a signal (e.g., signal #A) following an ongoing PSSCH in the PSFCH transmission occasion and the gap symbol(s) for the PSFCH transmission occasion (if any), without a gap larger than a minimum sensing interval (e.g., 16 us or 25 us). For example, UE #1 can transmit a signal following an ongoing PSSCH till the end of the slot where the PSFCH transmission occasion happens so as to fully occupy the slot. For example, the PSFCH transmission occasion and the gap symbol(s) for the PSFCH transmission occasion are used for transmitting signal #A. For example, the gap between a PSSCH in the slot and signal #A may be less than or equal to the minimum sensing interval.

Signal #A can be implemented in various manners. For example, signal #A can be a repetition of one or more last symbols of the ongoing PSSCH. For example, signal #A can be a repetition of one or more first symbols of the next slot. For example, signal #A can be any other signals that can be conceived of by persons skilled in the art.

For example, referring again to FIG. 2, assuming that UE #1 initiates COT 252 and determines that scenario #2 happens, UE #1 may use PSFCH occasion 222 and the gap symbols before and after PSFCH occasion 222 to transmit signal #A.

In some embodiments of the present disclosure, UE #1 can transmit a signal in the PSFCH transmission occasion only for reserving the channel.

For example, UE #1 may transmit an interlace-based channel (e.g., an interlace-based PSFCH) in the PSFCH transmission occasion (e.g., two symbols reserved for PSFCH transmission). The channel may be transmitted on an interlace randomly selected from the available interlaces or a default interlace (e.g., the lowest or highest interlace) predefined in a standard(s) or (pre)configured.

For the gap symbol before or after the PSFCH transmission occasion (if any), UE #1 may also transmit a signal(s) on the gap symbol(s) so that there is no gap larger than the minimum sensing interval (e.g., 16 us or 25 us). For example, UE #1 can extend the cyclic prefix (CP) of the first symbol of the interlace-based channel or the last symbol of an ongoing PSSCH in the gap symbol before the PSFCH transmission occasion. UE #1 can extend the CP of the first symbol of the next slot or the last symbol of the interlace-based channel in the gap symbol after the PSFCH transmission occasion.

As mentioned above, in some cases, scenario #3 may occur. For example, UE #1 can determine that itself will not transmit a PSFCH(s) in the PSFCH transmission occasion. UE #1 can also determine that its Rx UE(s) will not transmit a PSFCH(s) in the PSFCH transmission occasion based on, for example, the Rx UE(s) employs the ACK/NACK based feedback. However, UE #1 cannot determine whether its Rx UE(s) will transmit a PSFCH(s) in the PSFCH transmission occasion or not in the case that the Rx UE(s) employs the NACK-only based feedback. UE #1 also cannot determine whether there is another UE (e.g., UE #B) which will transmit a PSFCH(s) in the PSFCH transmission occasion in the case that, for example, the another UE employs the NACK-only based feedback or UE #1 does not receive or correctly decode a PSCCH for the another UE.

In this scenario, as described above, UE #1 may determine whether the channel is empty in the PSFCH transmission occasion by, for example, performing an energy detection or a channel access procedure. Based on the results, UE #1 may perform continuous transmissions in the PSFCH transmission occasion.

For example, in some embodiments of the present disclosure, UE #1 may detect the energy on an initial or first symbol of the PSFCH transmission occasion. If the detected energy is lower than an energy detection threshold (which may be predefined or (pre)configured), UE #1 may assume that there is no other UE transmitting a PSFCH in the current PSFCH transmission occasion. UE #1 may transmit a reservation signal from the second symbol of the current PSFCH transmission occasion till the end of the current slot. The reservation signals described with respect to scenario #2 may also apply here.

In some embodiments of the present disclosure, UE #1 may perform a channel access procedure (e.g., Type-2 channel access procedure) within the first symbol of the PSFCH transmission occasion. For example, UE #1 may perform Type-2 channel access procedure within the first 16 us or 25 us of the first symbol of the PSFCH transmission occasion, the last 16 us or 25 us of the first symbol of the PSFCH transmission occasion, or any 16 us or 25 us sensing interval within of the first symbol of the PSFCH transmission occasion. If the channel access procedure is successful, UE #1 may assume that there is no other UE transmitting PSFCH in the current PSFCH transmission occasion. In some examples, UE #1 may transmit a reservation signal from the beginning of the second symbols of the current PSFCH transmission occasion till the end of the current slot. In some examples, UE #1 may transmit a reservation signal after performing the channel access procedure till the end of the current slot. The reservation signals described with respect to scenario #2 may also apply here.

In some examples, from the perspective of an Rx UE (denoted as UE #2 for simplicity) of UE #1, UE #2 may receive, from UE #1, an SCI scheduling a PSSCH within a COT initiated by UE #1. UE #2 may determine whether the HARQ-ACK feedback for the received PSSCH is to be transmitted in a PSFCH transmission occasion inside of the COT. The PSFCH transmission occasion may be determined based on a PSFCH periodicity with reference to a PSFCH resource pool. In response to determining that the HARQ-ACK feedback is to be transmitted in the PSFCH transmission occasion inside of the COT, UE #2 may perform a channel access procedure (e.g., channel access Type 2) in a gap symbol for the PSFCH transmission occasion (e.g., one symbol before the PSFCH transmission occasion) within the COT. UE #2 may transmit, to UE #1, the HARQ-ACK feedback in the PSFCH transmission occasion in response to the channel access procedure being successful. UE #1 may perform a channel access procedure (e.g., channel access Type 2) after the PSFCH transmission occasion (e.g., in a gap symbol for the PSFCH transmission occasion) before it resumes its sidelink transmissions in the COT.

In some embodiments of the present disclosure, for sidelink transmissions over an unlicensed spectrum, PSFCH transmission occasions are determined based on a PSFCH periodicity with reference to a COT. For example, the PSFCH transmission occasions are confined within the COT and determined based on the PSFCH periodicity and the initial slot of the COT.

In some embodiments, the PSFCH periodicity may be configured by RRC signaling or predefined in a standard(s). For example, when the SCS is 15 kHz, the PSFCH periodicity can be equal to 2 or 4 slots; when the SCS is 30 kHz, the PSFCH periodicity can be equal to 2, 4 or 8 slots; and when the SCS is 60 kHz, the PSFCH periodicity can be equal to 2, 4, 6, 8, 10, 12 or 16 slots.

In some embodiments, the PSFCH periodicity may be based on a CAPC used for performing the channel access procedure which initiates the COT. For example, when the SCS is 15 kHz, for a CAPC value of 1 or 2, the PSFCH periodicity can be equal to 2 slots; and for a CAPC value of 3 or 4, the PSFCH periodicity can be equal to 4 slots. For example, when the SCS is 30 kHz, for a CAPC value of 1 or 2, the PSFCH periodicity can be equal to 2 or 4 slots; and for a CAPC value of 3 or 4, the PSFCH periodicity can be equal to 4 or 8 slots. For example, when the SCS is 60 kHz, for a CAPC value of 1 or 2, the PSFCH periodicity can be equal to 2 or 4 or 8 slots; and for a CAPC value of 3 or 4, the PSFCH periodicity can be equal to 4 or 8 or 10 or 12 or 16 slots. The detailed PSFCH periodicity can be configured by RRC signaling or predefined in a standard(s).

In some embodiments, the PSFCH periodicity may be based on the maximum duration of the COT. For example, when the SCS is 15 kHz, for a maximum duration of 2 ms, 3 ms or 4 ms, the PSFCH periodicity can be equal to 2 slots; and for a maximum duration of 6 ms, 8 ms or 10 ms, the PSFCH periodicity can be equal to 4 slots. For example, when the SCS is 30 kHz, for a maximum duration of 2 ms, 3 ms or 4 ms, the PSFCH periodicity can be equal to 2 or 4 slots; and for a maximum duration of 6 ms, 8 ms or 10 ms, the PSFCH periodicity can be equal to 4 or 8 slots. For example, when the SCS is 60 kHz, for a maximum duration of 2 ms, 3 ms or 4 ms, the PSFCH periodicity can be equal to 2 or 4 or 8 slots; and for a maximum duration of 6 ms, 8 ms or 10 ms, the PSFCH periodicity can be equal to 4 or 8 or 10 or 12 or 16 slots. The detailed PSFCH periodicity can be configured by RRC signaling or predefined in a standard(s).

For a UE intending to transmit HARQ-ACK feedback or a PSFCH, a channel access procedure (e.g., channel access Type 2) is performed before transmitting the HARQ-ACK feedback or PSFCH in a PSFCH transmission occasion. A Tx UE (denoted as UE #1A for simplicity) may initiate a COT by performing a channel access procedure (e.g., channel access Type 1). UE #1A may determine a PSFCH transmission occasion with reference to an initial slot of the COT. For example, a slot may have a PSFCH transmission occasion resource if k1 mod N1_{PSSCH}^{PSFCH}=0, where k1 denotes the slot index with reference to the initial slot of the COT (e.g., k=0 pointing to the initial slot of the COT), and N1_{PSSCH}^{PSFCH} denotes the PSFCH periodicity. The PSFCH transmission occasions would be dynamically changed in the time domain according to the CAPC or MCOT of the COT or configured by RRC signaling.

For a PSSCH transmitted by UE #1A in the COT, the corresponding PSFCH (or HARQ-ACK feedback) may be transmitted by the Rx UE(s) in a first (e.g., earliest) slot that includes PSFCH resources (e.g., PSFCH transmission occasions) and satisfies the Rx UE(s)'s processing delay requirements from the PSSCH to the corresponding PSFCH (or HARQ-ACK feedback). The PSFCH transmission occasions inside of the COT may be reserved by UE #1A for the Rx UE(s) to transmit the PSFCH (or HARQ-ACK feedback). A channel access procedure (e.g., channel access Type 2) may be required for the Rx UE(s) before transmitting a PSFCH (or HARQ-ACK feedback) inside of the COT.

In some examples, due to an Rx UE's processing delay requirements from a PSSCH to the corresponding PSFCH, if the PSFCH (or HARQ-ACK feedback) cannot be transmitted inside of the current COT, it may be automatically postponed by the Rx UE. UE #1A can initiate a new COT and trigger the Rx UE to transmit the postponed PSFCH (or HARQ-ACK feedback) in a PSFCH transmission occasion (e.g., the earliest PSFCH transmission occasion) inside of the new COT according to the PSFCH periodicity. As will be described in detail later, various embodiments are provided to implement the trigger mechanism of a PSFCH transmission occasion.

In some examples, a PSFCH transmission occasion can be cancelled when, for example, UE #1A decides to disable the HARQ-ACK feedback for PSSCHs transmitted in slots with corresponding HARQ-ACK feedback to be transmitted in the PSFCH transmission occasion within the COT. For the cancelled PSFCH transmission occasion, UE #1A may perform continuous transmissions in the PSFCH transmission occasion to fully use the channel and avoid the risk of losing the channel. As will be described in detail later, various embodiments are provided to implement the cancelling mechanism of a PSFCH transmission occasion. In another example, UE #1A may decide to disable the HARQ-ACK feedback for PSSCHs transmitted in the COT with corresponding HARQ-ACK feedback to be transmitted in a PSFCH transmission occasion outside of the COT.

In this way, PSFCH transmission occasions are always inside of a COT initiated by a Tx UE, which ensures a high LBT successful probability due to a channel access procedure (e.g., channel access Type 2) required. The ongoing sidelink transmission from UE #1A would not be interrupted by the PSFCH transmission occasion, especially when the PSFCH transmission occasion is located at the end of the COT. UE #1A can easily transmit a signal for reserving the channel in the PSFCH transmission occasion if it determines to disable the corresponding HARQ-ACK feedback transmission in the PSFCH transmission occasion. UE #1A can perform continuous transmissions to reserve the channel in the PSFCH transmission occasion (e.g., transmitting a reservation signal or a reservation transmission) under certain cases including, for example, if it determines to disable the corresponding HARQ-ACK feedback transmission in the PSFCH transmission occasion.

The trigger mechanism for requesting sidelink HARQ-ACK feedback (e.g., for a PSSCH in a previous COT) can be implemented in various manners.

For example, UE #1A may initiate a COT (denoted as COT #1A) and transmit a PSSCH in COT #1A to an Rx UE (denoted as UE #2A). In some examples, UE #1A may determine that the HARQ-ACK feedback (or PSFCH) for the PSSCH cannot be transmitted inside COT #1A. UE #1A may perform a channel access procedure (e.g., channel access Type 1) to initiate another COT (denoted as COT #2A) and may trigger UE #2A to transmit the postponed HARQ-ACK feedback in a PSFCH transmission occasion inside of COT #2A. COT #2A is outside of COT #1A.

In some embodiments of the present disclosure, UE #1A may transmit an SCI (denotes as SCI #A) in COT #2A to request UE #2A to transmit the postponed HARQ-ACK feedback in a PSFCH transmission occasion inside of COT #2A. For example, the PSFCH transmission occasion may be indicated by SCI #A. For example, the PSFCH transmission occasion may be a specific one (e.g., the earliest) of at least one PSFCH transmission occasion inside of COT #2A. The at least one PSFCH transmission occasion may be determined based on the PSFCH periodicity with reference to COT #2A.

For example, in some embodiments of the present disclosure, SCI #A may schedule a PSSCH in COT #2A. SCI #A may include a HARQ-ACK feedback request indicator requesting the postponed HARQ-ACK feedback to be transmitted inside of COT #2A. The size of the HARQ-ACK feedback request indicator can be at least one bit.

For example, when a UE (e.g., UE #1A) initiates a new COT, it can transmit an SCI with a HARQ-ACK feedback request indicator requesting an Rx UE(s) (e.g., UE #2A) to transmit the postponed HARQ-ACK feedback in the new COT. For an Rx UE, since it knows the postponed HARQ-ACK feedback (e.g., by determining the HARQ-ACK feedback that cannot be transmitted in a previous COT(s)), it may transmit the postponed HARQ-ACK feedback in the new COT in response to receiving the SCI, which includes the HARQ-ACK feedback request indicator.

In some embodiments of the present disclosure, SCI #A may schedule a PSSCH in COT #2A. SCI #A may include a HARQ process number field and a HARQ-ACK feedback request indicator requesting the transmission of HARQ-ACK feedback associated with the HARQ process number(s) indicated by the HARQ process number field in COT #2A. One or more HARQ process numbers can be indicated by the HARQ process number field in SCI #A and requested for transmitting corresponding HARQ-ACK feedback in the same PSFCH transmission occasion. That is, HARQ-ACK feedback associated with the HARQ process number(s) indicated by the HARQ process number field is requested to be transmitted in COT #2A. To put another way, the HARQ-ACK feedback to be transmitted in COT #2A corresponds to a previous PSSCH(s) associated with the HARQ process number(s) indicated by the HARQ process number field in SCI #A.

The HARQ-ACK feedback to be transmitted in COT #2A may include the postponed HARQ-ACK feedback which cannot be responded in a previous COT(s) due to, for example, UE processing delay, HARQ-ACK feedback which cannot be transmitted in a previous COT(s) due to a channel access process failure, HARQ-ACK feedback which cannot be correctly received in a previous COT(s) due to, for example, hidden node interference, or any combination thereof. To put another way, the HARQ process number(s) indicates by the HARQ process number field may include a HARQ process number associate with the postponed HARQ-ACK feedback, a HARQ process number associated with HARQ-ACK feedback which cannot be transmitted in a previous COT due to a channel access process failure, a HARQ process number associated with HARQ-ACK feedback which is not correctly received by UE #1A in a previous COT, or any combination thereof.

For example, when a UE (e.g., UE #1A) initiates a new COT, it can transmit an SCI with a HARQ-ACK feedback request indicator and associated HARQ process number indication (e.g., HARQ process number field) requesting an Rx UE(s) (e.g., UE #2A) to transmit the corresponding HARQ-ACK feedback in the new COT. For an Rx UE, since it can know the requested HARQ-ACK feedback based on the associated HARQ process number indication, it may transmit the requested HARQ-ACK feedback in the new COT in response to receiving the SCI, which includes the HARQ-ACK feedback request indicator and the associated HARQ process number indication.

SCI #A may further include another HARQ process number field indicating the HARQ process number associated with the PSSCH scheduled by SCI #A or the HARQ-ACK feedback for the scheduled PSSCH.

In some embodiments of the present disclosure, SCI #A may schedule a PSSCH in COT #2A. Compared with the previous embodiments, SCI #A may not include a HARQ-ACK feedback request indicator. SCI #A may include a HARQ process number field (denoted as field #1) requesting the transmission of HARQ-ACK feedback associated with the HARQ process number(s) indicated by field #1 in COT #2A. One or more HARQ process numbers can be indicated by field #1 in SCI #A and requested for transmitting corresponding HARQ-ACK feedback in the same PSFCH transmission occasion. That is, HARQ-ACK feedback associated with the HARQ process number(s) indicated by field #1 is requested to be transmitted in COT #2A. To put another way, the HARQ-ACK feedback to be transmitted in COT #2A corresponds to a previous PSSCH(s) associated with the HARQ process number(s) indicated by field #1 in SCI #A.

The HARQ-ACK feedback to be transmitted in COT #2A may include the postponed HARQ-ACK feedback which cannot be responded in a previous COT(s) due to, for example, UE processing delay, HARQ-ACK feedback which cannot be transmitted in a previous COT(s) due to a channel access process failure, HARQ-ACK feedback which cannot be correctly received in a previous COT(s) due to, for example, hidden node interference, or any combination thereof. To put another way, the HARQ process number(s) indicates by field #1 may include a HARQ process number associate with the postponed HARQ-ACK feedback, a HARQ process number associated with HARQ-ACK feedback which cannot be transmitted in a previous COT due to a channel access process failure, a HARQ process number associated with HARQ-ACK feedback which is not correctly received by UE #1A in a previous COT, or any combination thereof.

SCI #A may further include another HARQ process number field (denoted as field #2) indicating the HARQ process number associated with the PSSCH scheduled by SCI #A or the HARQ-ACK feedback for the scheduled PSSCH. In some embodiments, in the case that field #1 indicates a HARQ process number the same as field #2, it may suggest that field #1 does not request the transmission of any HARQ-ACK feedback corresponding to a previous PSSCH. That is, the same HARQ process number being indicated by the two HARQ process number fields in an SCI may indicate an invalid case.

For example, when a UE (e.g., UE #1A) initiates a new COT, it can transmit an SCI with HARQ process number indication (e.g., HARQ process number field) requesting an Rx UE(s) (e.g., UE #2A) to transmit the corresponding HARQ-ACK feedback for a previous PSSCH(s) in the new COT. For an Rx UE, since it can know the requested HARQ-ACK feedback based on the HARQ process number indication, it may transmit the requested HARQ-ACK feedback in the new COT in response to receiving the SCI, which includes the HARQ process number indication.

In some embodiments of the present disclosure, SCI #A may be an SCI specific for requesting HARQ-ACK feedback. That is, a new SCI format may be introduced for requesting HARQ-ACK feedback for a previous PSSCH(s). SCI #A may not schedule any PSSCH.

For example, SCI #A may include a HARQ process number field indicating a HARQ process number(s) associated with the HARQ-ACK feedback to be transmitted in COT #2A. One or more HARQ process numbers can be indicated by the HARQ process number field in SCI #A and requested for transmitting corresponding HARQ-ACK feedback in the same PSFCH transmission occasion. To put another way, the HARQ-ACK feedback to be transmitted in COT #2A corresponds to a previous PSSCH(s) associated with the HARQ process number(s) indicated by the HARQ process number field in SCI #A.

The HARQ-ACK feedback to be transmitted in COT #2A may include the postponed HARQ-ACK feedback which cannot be responded in a previous COT(s) due to, for example, UE processing delay, HARQ-ACK feedback which cannot be transmitted in a previous COT(s) due to a channel access process failure, HARQ-ACK feedback which cannot be correctly received in a previous COT(s) due to, for example, hidden node interference, or any combination thereof. To put another way, the HARQ process number(s) indicates by the HARQ process number field may include a HARQ process number associate with the postponed HARQ-ACK feedback, a HARQ process number associated with HARQ-ACK feedback which cannot be transmitted in a previous COT due to a channel access process failure, a HARQ process number associated with HARQ-ACK feedback which is not correctly received by UE #1A in a previous COT, or any combination thereof.

For example, when a UE (e.g., UE #1A) initiates a new COT, it can transmit an SCI with HARQ process number indication (e.g., HARQ process number field) requesting an Rx UE(s) (e.g., UE #2A) to transmit the corresponding HARQ-ACK feedback in the new COT. For an Rx UE, since it can know the requested HARQ-ACK feedback (as well as the corresponding PSSCH(s)) based on the HARQ process number indication, it may transmit the requested HARQ-ACK feedback in the new COT in response to receiving the SCI, which includes the HARQ process number indication.

The cancelling mechanism of a PSFCH transmission occasion can be implemented in various manners.

For example, UE #1A may initiate a COT (denoted as COT #1B) and transmit a PSSCH in COT #1B to an Rx UE (e.g., UE #2A). UE #1A may determine a PSFCH transmission occasion within COT #1B. However, in some cases, UE #1A may determine to cancel the PSFCH transmission occasion within COT #1B. The following are some examples of such cases. For example, the HARQ-ACK feedback for PSSCHs transmitted in slots with corresponding HARQ-ACK feedback to be transmitted in the PSFCH transmission occasion is disabled. For example, no HARQ-ACK feedback is to be transmitted in the PSFCH transmission occasion. For instance, UE #1A may determine that HARQ-ACK feedback for the PSSCH(s) transmitted in slots within COT #1B is to be transmitted outside COT #1B. In response to the above cases, UE #1A may determine to cancel the PSFCH transmission occasion. In response to determining to cancel the PSFCH transmission occasion, UE #1A may perform continuous transmission in the cancelled PSFCH transmission occasion. The continuous transmissions can be implemented in various manners.

For example, in some embodiments of the present disclosure, UE #1A can continuously transmit an ongoing PSSCH in the PSFCH transmission occasion. For example, UE #1A can continuously transmit an ongoing PSSCH till the end of the slot where the PSFCH transmission occasion is cancelled so as to fully occupy the slot. For example, the PSFCH transmission occasion and the gap symbol(s) for the PSFCH transmission occasion (if any) may be used by an ongoing PSSCH for sidelink transmission. The gap symbol(s) for the PSFCH transmission occasion may include a symbol (e.g., one symbol) before the PSFCH transmission occasion, a symbol (e.g., one symbol) after the PSFCH transmission occasion, or both as described above. In these embodiments, no symbol is wasted for the cancelled PSFCH transmission occasion.

In some embodiments of the present disclosure, UE #1A can continuously transmit a signal (e.g., signal #B) following an ongoing PSSCH in the cancelled PSFCH transmission occasion and the gap symbol(s) for the PSFCH transmission occasion (if any), without a gap larger than a minimum sensing interval (e.g., 16 us or 25 us). For example, UE #1A can transmit a signal following an ongoing PSSCH till the end of the slot where the PSFCH transmission occasion is cancelled so as to fully occupy the slot. For example, the PSFCH transmission occasion and the gap symbol(s) for the PSFCH transmission occasion are used for transmitting signal #B. For example, the gap between a PSSCH in the slot and signal #B may be less than or equal to the minimum sensing interval.

Signal #B can be implemented in various manners. For example, signal #B can be a repetition of one or more last symbols of the ongoing PSSCH. For example, signal #B can be a repetition of one or more first symbols of the next slot. For example, signal #B can be any other signals that can be conceived of by persons skilled in the art.

In some embodiments of the present disclosure, UE #1A can transmit a signal in the cancelled PSFCH transmission occasion only for reserving the channel.

For example, UE #1A may transmit an interlace-based channel (e.g., an interlace-based PSFCH) in the cancelled PSFCH transmission occasion (e.g., two symbols reserved for PSFCH transmission). The channel may be transmitted on an interlace randomly selected from the available interlaces or a default interlace (e.g., the lowest or highest interlace) predefined in a standard(s) or (pre)configured.

For the gap symbol before or after the cancelled PSFCH transmission occasion (if any), UE #1A may also transmit a signal(s) on the gap symbol(s) so that there is no gap larger than the minimum sensing interval (e.g., 16 us or 25 us). For example, UE #1A can extend the cyclic prefix (CP) of the first symbol of the interlace-based channel or the last symbol of an ongoing PSSCH in the gap symbol before the PSFCH transmission occasion. UE #1A can extend the CP of the first symbol of the next slot or the last symbol of the interlace-based channel in the gap symbol after the PSFCH transmission occasion.

In some examples, from the perspective of a Tx UE (e.g., UE #1A), UE #1A may transmit, to an Rx UE (e.g., UE #2A), an SCI scheduling a PSSCH within a COT initiated by UE #1A. UE #1A may determine a PSFCH transmission occasion within the COT based on a PSFCH periodicity with reference to the COT. UE #1A may determine whether the HARQ-ACK feedback for the scheduled PSSCH is to be transmitted in the PSFCH transmission occasion inside of the COT, or to be transmitted outside of the COT, or the PSFCH transmission occasion is cancelled.

In some examples, UE #1A may determine whether the HARQ-ACK feedback for the scheduled PSSCH is to be transmitted in the PSFCH transmission occasion inside of the COT. In response to determining that the HARQ-ACK feedback is to be transmitted in the PSFCH transmission occasion inside of the COT. UE #1A may leave gap symbols for the first PSFCH occasion within the COT blank. In some examples, UE #1A may determine to cancel the PSFCH transmission occasion inside of the COT and may perform continuous transmission in the cancelled PSFCH occasion. In some examples, UE #1A may determine that the HARQ-ACK feedback is to be transmitted outside the COT, may thus initiate a new COT after the previous COT and may trigger UE #2A to transmit the HARQ-ACK feedback in the new COT.

In some embodiments, from the perspective of an Rx UE (e.g., UE #2A) of UE #1A, UE #2A may receive, from UE #1A, an SCI scheduling a PSSCH within a COT initiated by UE #1A. UE #2A may determine whether the HARQ-ACK feedback for the received PSSCH is to be transmitted in the PSFCH transmission occasion inside of the COT. The PSFCH transmission occasion may be determined based on a PSFCH periodicity with reference to the COT. In response to determining that the HARQ-ACK feedback is to be transmitted in the PSFCH transmission occasion inside of the COT. UE #2A may perform a channel access procedure (e.g., channel access Type 2) in a gap symbol for the PSFCH transmission occasion (e.g., one symbol before the PSFCH transmission occasion) within the COT. UE #2A may transmit, to UE #1A, the HARQ-ACK feedback in the PSFCH transmission occasion in response to the channel access procedure being successful. UE #1A may perform a channel access procedure (e.g., channel access Type 2) after the PSFCH transmission occasion (e.g., in a gap symbol for the PSFCH transmission occasion) before it resumes its sidelink transmissions in the COT.

In some examples, UE #2A may determine that the HARQ-ACK feedback for the received PSSCH is disabled, and may thus not transmit in the PSFCH transmission occasion. In some examples, in response to determining that the HARQ-ACK feedback is to be transmitted outside of the COT, UE #2A may postpone the transmission of the HARQ-ACK feedback until receiving a triggering signal requesting the transmission of the HARQ-ACK feedback. For example, UE #2A may receive an SCI from UE #1A in a new COT initiated by UE #1A for requesting the transmission of the HARQ-ACK feedback in a PSFCH occasion within the new COT. The PSFCH occasion within the new COT is determined based on the PSFCH periodicity with reference to the new COT. UE #2A may then transmit the requested HARQ-ACK feedback in the PSFCH occasion within the new COT.

FIG. 3 shows exemplary periodic PFSCH configuration 300 in accordance with some embodiments of the present disclosure. In FIG. 3, the PSFCH periodicity is 4 slots. The PSFCH transmission occasions are determined based on the PSFCH periodicity and the initial slot of a COT. For example, a UE(s) may initiate COT 351 and COT 352. Based on the PSFCH periodicity and initial slot of COT 351, slot n+4 may include PFSCH occasion 321. Based on the PSFCH periodicity and initial slot of COT 352, slot n+10 and slot n+14 may include PFSCH occasions 322 and 323, respectively.

In some examples, a Tx UE which initiates COT 351 may transmit PSSCHs 311 and 312 in slot n+1 and slot n+2. The HARQ-ACK feedback for PSSCHs 311 and 312 may be transmitted in PSFCH occasion 321. The Tx UE may leave a gap symbol before PSFCH occasion 321 blank such that the Rx UE(s) which receives PSSCHs 311 and 312 may perform a channel access procedure in the gap symbol.

The Tx UE may also transmit PSSCHs 313 and 314 in slot n+3 and slot n+4. The HARQ-ACK feedback for PSSCHs 313 and 314 may be transmitted outside of COT 351. Therefore, the HARQ-ACK feedback for PSSCHs 313 and 314 may be postponed. The Rx UE(s) which receives PSSCHs 313 and 314 may wait for a triggering signal requesting the transmission of the HARQ-ACK feedback for PSSCHs 313 and 314. In some examples, the Tx UE may initiate COT 352 and may transmit an SCI to trigger the transmission of the HARQ-ACK feedback for PSSCHs 313 and 314 in PFSCH occasion 322. The Tx UE may also transmit PSSCHs 315-319 and 331-333 in slots n+7 to n+14, respectively. The HARQ-ACK feedback for PSSCHs 315-319 and 331 may be transmitted inside of COT 352. For example, HARQ-ACK feedback for PSSCHs 315 and 316 may be transmitted in PFSCH occasion 322, along with the postponed HARQ-ACK feedback for PSSCHs 313 and 314. HARQ-ACK feedback for PSSCHs 317-319 and 331 may be transmitted in PFSCH occasion 323. HARQ-ACK feedback for PSSCHs 332 and 333 may be transmitted outside of COT 352 and thus may be postponed. The HARQ-ACK feedback for PSSCHs 332 and 333 may be triggered for transmission in a similar manner as the HARQ-ACK feedback for PSSCHs 313 and 314.

In some embodiments of the present disclosure, for sidelink transmissions over an unlicensed spectrum, PSFCH transmission occasions may be dynamically determined based on HARQ-ACK feedback timing from a PSSCH to the corresponding PSFCH.

For a UE intending to transmit a PSFCH, a channel access procedure (e.g., channel access Type 1 or channel access Type 2) is performed before transmitting the PSFCH in a PSFCH transmission occasion. The PSFCH transmission occasion may be defined with reference to the slot where the corresponding PSSCH is transmitted and a dynamically indicated slot level offset. For example, a slot k may have a PSFCH transmission occasion resource if k=n+x, where x is the dynamically indicated slot level offset and n is the slot where the corresponding PSSCH is transmitted. In this way, the PSFCH transmission occasions are totally dynamically changed in the time domain.

A Tx UE (denoted as UE #1B for simplicity) may initiate a COT by performing a channel access procedure (e.g., channel access Type 1). UE #1B may transmit at least one SCI scheduling at least one PSSCH in the COT. UE #1B may dynamically determine a PSFCH transmission occasion corresponding to the at least one PSSCH transmitted in a set of slots in the COT. In some embodiments, an SCI may include a HARQ-ACK feedback timing indicator for UE #1B to determine a PSFCH transmission occasion for transmitting the HARQ-ACK feedback for the scheduled PSSCH.

For example, the HARQ-ACK feedback timing indicator included in an SCI may indicate a slot level offset between the slot where a PSSCH scheduled by the SCI is transmitted and the slot where the corresponding PSFCH transmission occasion is determined (e.g., the slot where the HARQ-ACK feedback for the scheduled PSSCH is transmitted). For example, UE #1B may determine a PSFCH transmission occasion in slot k corresponding to a PSSCH transmitted in slot n, and then UE #1B may indicate a slot level offset of x=k−n via the HARQ-ACK feedback timing indicator.

In some embodiments, the slot level offset may be indicated from a set of HARQ-ACK feedback timing values, which may include {0, +1, +2, +3, +4, +5, +6, +7} or other larger or smaller values. In some embodiments, the set of HARQ-ACK feedback timing values may be configured by RRC signaling or predefined in a standard(s). Assuming the set of HARQ-ACK feedback timing values includes N values, then at least [log₂ N] bits may be required in an SCI for indicating one value from the set of values.

In this way, the PSFCH transmission occasions may be changed according to UE #1B's transmission policy and may be different from one COT to another.

In some embodiments, UE #1B may determine the HARQ-ACK feedback corresponding to a PSSCH is to be transmitted in the current COT. In some embodiments, UE #1B may postpone the HARQ-ACK feedback corresponding to a PSSCH if the HARQ-ACK feedback is to be transmitted outside of the current COT. In some embodiments, UE #1B may trigger the corresponding Rx UE to transmit the postponed the HARQ-ACK feedback after UE #1B initiates a new COT. In some embodiments, UE #1B may indicate the corresponding Rx UE to transmit the HARQ-ACK feedback even it may be transmitted outside of the current COT. In some embodiments, UE #1B may indicate the corresponding Rx UE to disable the HARQ-ACK feedback. Correspondingly, the PSFCH transmission occasion is dynamically indicated by UE #1B for the Rx UE to transmit HARQ-ACK feedback for a corresponding PSSCH. Details regarding the relation between the transmission policy, the PSFCH transmission occasion, and the HARQ-ACK feedback timing indicator will be described in the following text.

In some embodiments, a channel access type (or LBT type) may also be indicated in the SCI for an Rx UE to transmit the corresponding HARQ-ACK feedback or PSFCH. For example, in the case that the HARQ-ACK feedback or PSFCH for a PSSCH is to be transmitted inside of a COT initiated by UE #1B, UE #1B may indicate channel access Type 2 (e.g., channel access Type-2A, 2B, or 2C) to the Rx UE which receives the PSSCH. For example, in the case that the HARQ-ACK feedback or PSFCH for a PSSCH is to be transmitted outside of a COT initiated by UE #1B, UE #1B may indicate channel access Type 1 to the Rx UE which receives the PSSCH. In some embodiments, the channel access type may be indicated with CAPC or CP extension in the SCI. In some embodiments, the channel access type may be separately indicated in the SCI (for example, without the CAPC or CP extension).

In some embodiments, an indicator may also be included in the SCI for indicating whether the HARQ-ACK feedback or PSFCH corresponding to a PSSCH scheduled by the SCI is to be transmitted inside of the COT or outside of the COT. For example, in the case that the HARQ-ACK feedback or PSFCH for the PSSCH is to be transmitted inside of a COT initiated by UE #1B, UE #1B may indicate the HARQ-ACK feedback or PSFCH is inside of the COT, so that Rx UE can perform channel access Type 2 (e.g., channel access Type-2A, 2B, or 2C) before transmitting the HARQ-ACK feedback or PSFCH. For example, in the case that the HARQ-ACK feedback or PSFCH for a PSSCH is to be transmitted outside of a COT initiated by UE #1B, UE #1B may indicate the HARQ-ACK feedback or PSFCH is outside of the COT, so that Rx UE can perform channel access Type 1 before transmitting the HARQ-ACK feedback or PSFCH. This indicator can include at least one bit. For example, value “0” of the indicator indicates the HARQ-ACK feedback or PSFCH for the PSSCH is to be transmitted inside of a COT and value “1” of the indicator indicates the HARQ-ACK feedback or PSFCH for the PSSCH is to be transmitted outside of a COT; or vice versa.

In this way, a PSFCH transmission occasion can be inside of the COT initiated by a Tx UE, which ensures a high LBT successful probability due to a channel access procedure (e.g., channel access Type 2 such as channel access Type 2A, 2B, or 2C) required. The ongoing sidelink transmission from UE #1B would be not interrupted by the PSFCH transmission occasion, especially when the PSFCH transmission occasion is located at the end of the current COT or outside of the current COT. UE #1B can easily trigger an Rx UE to (re)transmit the sidelink HARQ-ACK feedback if it is outside of the current COT or not successfully received. There is no need to define a PSFCH periodicity in these embodiments.

As described above, the PSFCH transmission occasion may be dynamically changed according to a Tx UE's transmission policy. For example, UE #1B may initiate a COT (denoted as COT #1C). UE #1B may transmit, to an Rx UE (denoted as UE #2B), an SCI in COT #1C to schedule a PSSCH in COT #1C. UE #1B may set the HARQ-ACK feedback timing indicator in the SCI based on the transmission policy.

For example, UE #1B may determine whether HARQ-ACK feedback for the schedules PSSCH is to be transmitted in COT #1C (e.g., in a PSFCH transmission occasion in COT #1C).

In some embodiments, in response to determining that the HARQ-ACK feedback for the PSSCH is to be transmitted inside of COT #1C (e.g., based on the UE processing delay), UE #1B may set the HARQ-ACK feedback timing indicator in the SCI to indicate a HARQ-ACK feedback timing value (i.e., an applicable value) for indicating a PSFCH transmission occasion for transmitting the HARQ-ACK feedback. The PSFCH transmission occasion is within COT #1C. UE #2B may perform a channel access procedure (e.g., channel access Type 2 such as channel access Type 2A, 2B, or 2C) before transmitting the HARQ-ACK feedback or PSFCH in the PSFCH transmission occasion inside of the COT.

For example, UE #1B may leave gap symbol(s) for the PSFCH transmission occasion blank. UE #2B may perform a channel access procedure in a gap symbol before the PSFCH transmission occasion. For example, UE #1B may perform a channel access procedure (e.g., channel access Type 2) in a gap symbol after the PSFCH transmission occasion before UE #1B resumes the transmission (e.g., in the next slot) in COT #1C.

In some embodiments, in response to determining that the HARQ-ACK feedback for the PSSCH is to be transmitted outside of COT #1C (e.g., based on the UE processing delay), UE #1B may set the HARQ-ACK feedback timing indicator in the SCI to indicate an inapplicable HARQ-ACK feedback timing value or a reserved code point. In this way, the HARQ-ACK feedback is postponed. The inapplicable HARQ-ACK feedback timing value may be from a set of HARQ-ACK feedback timing values and may be a negative value (e.g., −1). UE #1B may initiate a new COT after COT #1C, and then trigger UE #2B to transmit the postponed HARQ-ACK feedback in a PSFCH transmission occasion inside of the new COT. For example, UE #1B may perform a channel access procedure (e.g., channel access Type 1) to initiate the new COT, and may transmit an SCI in the new COT to request UE #2B to transmit the HARQ-ACK feedback in a PSFCH transmission occasion inside of the new COT. The PSFCH transmission occasion inside of the new COT may be determined based on a HARQ-ACK feedback timing value (e.g., an applicable value) indicated by a HARQ-ACK feedback timing indicator in the SCI transmitted in the new COT.

In some embodiments, in response to determining that the HARQ-ACK feedback for the PSSCH is to be transmitted outside of COT #1C (e.g., based on the UE processing delay), UE #1B may set the HARQ-ACK feedback timing indicator in the SCI to indicate a HARQ-ACK feedback timing value for indicating a PSFCH transmission occasion for transmitting the HARQ-ACK feedback. The PSFCH transmission occasion is outside of COT #1C. That is, the indicated HARQ-ACK feedback timing value is an applicable value and points to a slot outside of COT #1C.

In response to receiving the SCI. UE #2B may perform a channel access procedure for transmitting the HARQ-ACK feedback in the indicated PSFCH transmission occasion. For example, the channel access procedure may be a channel access Type 1 procedure for initiating a new COT. The indicated PSFCH transmission occasion is within the new COT. The channel access procedure may be associated with the lowest CAPC value. For example, the channel access procedure may be a channel access Type 2 procedure.

In some examples, in response to the channel access procedure being successful, UE #2B may transmit the HARQ-ACK feedback in the indicated PSFCH transmission occasion. In response to the channel access procedure being unsuccessful, UE #2B may drop the indicated PSFCH transmission occasion (or the PSFCH or HARQ-ACK feedback intended to be transmitted in the PSFCH occasion).

UE #1B may attempt to receive the HARQ-ACK feedback (or PSFCH) in the indicated PSFCH transmission occasion after it indicates UE #2B the applicable HARQ-ACK feedback timing value. In some embodiments, when UE #1B fails to detect or receive the HARQ-ACK feedback (or PSFCH) from UE #2B in the indicated PSFCH transmission occasion, UE #1B may trigger UE #2B to (re)transmit the HARQ-ACK feedback (or PSFCH) in a new COT initiated by UE #1B. For example, UE #1B may transmit an SCI in the new COT initiated by UE #1B to UE #2B for requesting the transmission of the HARQ-ACK feedback in the new COT.

In some embodiments, UE #1B may determine whether to disable the HARQ-ACK feedback for the PSSCH scheduled in COT #1C. In response to determining to disable the HARQ-ACK feedback for the PSSCH, UE #1B may perform at least one of the following: set the HARQ-ACK feedback timing indicator in the SCI schedule the PSSCH to indicate a specific HARQ-ACK feedback timing value or a reserved code point; or set a HARQ enabling/disabling indicator in the SCI schedule the PSSCH to disable HARQ-ACK feedback for the first PSSCH. The specific HARQ-ACK feedback timing value may be an inapplicable value (e.g., −2). The specific HARQ-ACK feedback timing value may be a predefined value. The specific HARQ-ACK feedback timing value may be from a set of HARQ-ACK feedback timing values. The HARQ enabling/disabling indicator may include at least one bit indicating whether the corresponding HARQ-ACK feedback is disabled or enabled.

The trigger mechanism for requesting sidelink HARQ-ACK feedback (e.g., for a PSSCH in a previous COT) can be implemented in various manners.

For example, UE #1B may initiate a COT (denoted as COT #1D) and transmit a PSSCH in COT #1D to an Rx UE (e.g., UE #2B). In some examples, UE #1B may determine that the HARQ-ACK feedback (or PSFCH) for the PSSCH cannot be transmitted inside COT #1D. UE #1B may perform a channel access procedure (e.g., channel access Type 1) to initiate another COT (denoted as COT #2D) and may trigger UE #2B to transmit the postponed HARQ-ACK feedback in a PSFCH transmission occasion inside of COT #2D. COT #2D is outside of COT #1D.

In some embodiments of the present disclosure, UE #1B may transmit an SCI (denotes as SCI #B) in COT #2D to request UE #2B to transmit the postponed HARQ-ACK feedback in a PSFCH transmission occasion inside of COT #2D. The PSFCH transmission occasion may be indicated by a HARQ-ACK feedback timing indicator in SCI #B and may be inside of COT #2D. For example, HARQ-ACK feedback timing indicator in SCI #B may indicate an applicable HARQ-ACK feedback timing value from a set of HARQ-ACK feedback timing values.

For example, in some embodiments of the present disclosure, SCI #B may schedule a PSSCH in COT #2D. SCI #B may include a HARQ-ACK feedback request indicator requesting the postponed HARQ-ACK feedback to be transmitted inside of COT #2D. The size of the HARQ-ACK feedback request indicator can be at least one bit.

For example, when a UE (e.g., UE #1B) initiates a new COT, it can transmit an SCI with a HARQ-ACK feedback request indicator requesting an Rx UE(s) (e.g., UE #2B) to transmit the postponed HARQ-ACK feedback in the new COT. For an Rx UE, since it knows the postponed HARQ-ACK feedback (e.g., by determining the HARQ-ACK feedback that cannot be transmitted in a previous COT(s)), it may transmit the postponed HARQ-ACK feedback in the new COT in response to receiving the SCI, which includes the HARQ-ACK feedback request indicator.

In some embodiments of the present disclosure, SCI #B may schedule a PSSCH in COT #2D. SCI #B may include a HARQ process number field and a HARQ-ACK feedback request indicator requesting the transmission of HARQ-ACK feedback associated with the HARQ process number(s) indicated by the HARQ process number field in COT #2D. One or more HARQ process numbers can be indicated by the HARQ process number field in SCI #B and requested for transmitting corresponding HARQ-ACK feedback in the same PSFCH transmission occasion. That is, HARQ-ACK feedback associated with the HARQ process number(s) indicated by the HARQ process number field is requested to be transmitted in COT #2D. To put another way, the HARQ-ACK feedback to be transmitted in COT #2D corresponds to a previous PSSCH(s) associated with the HARQ process number(s) indicated by the HARQ process number field in SCI #B.

The HARQ-ACK feedback to be transmitted in COT #2D may include the postponed HARQ-ACK feedback which cannot be responded in a previous COT(s) due to, for example, UE processing delay, HARQ-ACK feedback which cannot be transmitted in a previous COT(s) due to a channel access process failure, HARQ-ACK feedback which cannot be correctly received in a previous COT(s) due to, for example, hidden node interference, or any combination thereof. To put another way, the HARQ process number(s) indicates by the HARQ process number field may include a HARQ process number associate with the postponed HARQ-ACK feedback, a HARQ process number associated with HARQ-ACK feedback which cannot be transmitted in a previous COT due to a channel access process failure, a HARQ process number associated with HARQ-ACK feedback which is not correctly received by UE #1B in a previous COT, or any combination thereof.

For example, when a UE (e.g., UE #1B) initiates a new COT, it can transmit an SCI with a HARQ-ACK feedback request indicator and associated HARQ process number indication (e.g., HARQ process number field) requesting an Rx UE(s) (e.g., UE #2B) to transmit the corresponding HARQ-ACK feedback in the new COT. For an Rx UE, since it can know the requested HARQ-ACK feedback based on the associated HARQ process number indication, it may transmit the requested HARQ-ACK feedback in the new COT in response to receiving the SCI, which includes the HARQ-ACK feedback request indicator and the associated HARQ process number indication.

SCI #B may further include another HARQ process number field indicating the HARQ process number associated with the PSSCH scheduled by SCI #B or the HARQ-ACK feedback for the scheduled PSSCH.

In some embodiments of the present disclosure, SCI #B may schedule a PSSCH in COT #2D. Compared with the previous embodiments, SCI #B may not include a HARQ-ACK feedback request indicator. SCI #B may include a HARQ process number field (denoted as field #1′) requesting the transmission of HARQ-ACK feedback associated with the HARQ process number(s) indicated by field #1′ in COT #2D. One or more HARQ process numbers can be indicated by field #1′ in SCI #B and requested for transmitting corresponding HARQ-ACK feedback in the same PSFCH transmission occasion. That is, HARQ-ACK feedback associated with the HARQ process number(s) indicated by field #1′ is requested to be transmitted in COT #2D. To put another way, the HARQ-ACK feedback to be transmitted in COT #2D corresponds to a previous PSSCH(s) associated with the HARQ process number(s) indicated by field #1′ in SCI #B.

The HARQ-ACK feedback to be transmitted in COT #2D may include the postponed HARQ-ACK feedback which cannot be responded in a previous COT(s) due to, for example, UE processing delay, HARQ-ACK feedback which cannot be transmitted in a previous COT(s) due to a channel access process failure, HARQ-ACK feedback which cannot be correctly received in a previous COT(s) due to, for example, hidden node interference, or any combination thereof. To put another way, the HARQ process number(s) indicates by field #1′ may include a HARQ process number associate with the postponed HARQ-ACK feedback, a HARQ process number associated with HARQ-ACK feedback which cannot be transmitted in a previous COT due to a channel access process failure, a HARQ process number associated with HARQ-ACK feedback which is not correctly received by UE #1B in a previous COT, or any combination thereof.

SCI #B may further include another HARQ process number field (denoted as field #2′) indicating the HARQ process number associated with the PSSCH scheduled by SCI #B or the HARQ-ACK feedback for the scheduled PSSCH. In some embodiments, in the case that field #1′ indicates a HARQ process number the same as field #2′, it may suggest that field #1′ does not request the transmission of any HARQ-ACK feedback corresponding to a previous PSSCH. That is, the same HARQ process number being indicated by the two HARQ process number fields in an SCI may indicate an invalid case.

For example, when a UE (e.g., UE #1B) initiates a new COT, it can transmit an SCI with HARQ process number indication (e.g., HARQ process number field) requesting an Rx UE(s) (e.g., UE #2B) to transmit the corresponding HARQ-ACK feedback for a previous PSSCH(s) in the new COT. For an Rx UE, since it can know the requested HARQ-ACK feedback based on the HARQ process number indication, it may transmit the requested HARQ-ACK feedback in the new COT in response to receiving the SCI, which includes the HARQ process number indication.

In some embodiments of the present disclosure, SCI #B may be an SCI specific for requesting HARQ-ACK feedback. That is, a new SCI format may be introduced for requesting HARQ-ACK feedback for a previous PSSCH(s). SCI #B may not schedule any PSSCH and the HARQ-ACK feedback timing indicator included in the SCI may indicate the HARQ-ACK feedback timing from the slot where the SCI is transmitted and the slot where the HARQ-ACK feedback is to be transmitted.

For example, SCI #B may include a HARQ process number field indicating a HARQ process number(s) associated with the HARQ-ACK feedback to be transmitted in COT #2D. One or more HARQ process numbers can be indicated by the HARQ process number field in SCI #B and requested for transmitting corresponding HARQ-ACK feedback in the same PSFCH transmission occasion. To put another way, the HARQ-ACK feedback to be transmitted in COT #2D corresponds to a previous PSSCH(s) associated with the HARQ process number(s) indicated by the HARQ process number field in SCI #B.

The HARQ-ACK feedback to be transmitted in COT #2D may include the postponed HARQ-ACK feedback which cannot be responded in a previous COT(s) due to, for example, UE processing delay, HARQ-ACK feedback which cannot be transmitted in a previous COT(s) due to a channel access process failure, HARQ-ACK feedback which cannot be correctly received in a previous COT(s) due to, for example, hidden node interference, or any combination thereof. To put another way, the HARQ process number(s) indicates by the HARQ process number field may include a HARQ process number associate with the postponed HARQ-ACK feedback, a HARQ process number associated with HARQ-ACK feedback which cannot be transmitted in a previous COT due to a channel access process failure, a HARQ process number associated with HARQ-ACK feedback which is not correctly received by UE #1B in a previous COT, or any combination thereof.

For example, when a UE (e.g., UE #1B) initiates a new COT, it can transmit an SCI with HARQ process number indication (e.g., HARQ process number field) requesting an Rx UE(s) (e.g., UE #2B) to transmit the corresponding HARQ-ACK feedback in the new COT. For an Rx UE, since it can know the requested HARQ-ACK feedback (as well as the corresponding PSSCH(s)) based on the HARQ process number indication, it may transmit the requested HARQ-ACK feedback in the new COT in response to receiving the SCI, which includes the HARQ process number indication.

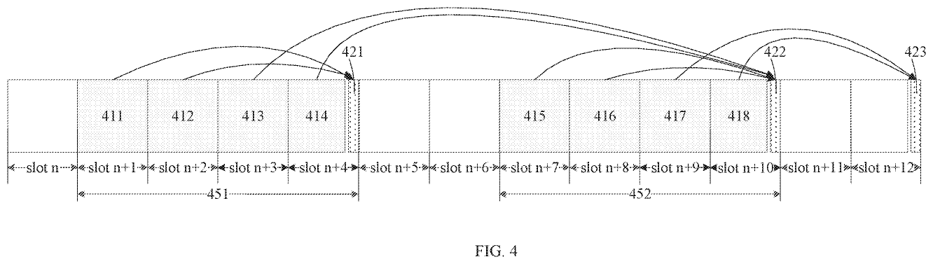

FIG. 4 shows exemplary dynamic PFSCH transmission occasions in accordance with some embodiments of the present disclosure. In FIG. 4, the PSFCH transmission occasions are dynamically determined.

For example, a Tx UE which initiates COT 451 may transmit SCIs to schedule PSSCHs 411-414 in slots n+1 to n+4. The Tx UE may determine that the HARQ-ACK feedback for PSSCHs 411 and 412 can be transmitted within COT 451, and may then set the HARQ-ACK feedback timing indicators in the SCIs scheduling PSSCHs 411 and 412 to indicate PSFCH occasion 421 or slot n+4 where PSFCH occasion 421 is located. The Tx UE may leave a gap symbol before PSFCH occasion 421 blank such that the Rx UE(s) which receives PSSCHs 411 and 412 may perform a channel access procedure in the gap symbol. The Rx UE(s) which receives PSSCHs 411 and 412 may determine PSFCH occasion 421 in response to receiving the corresponding SCIs. Before transmitting the HARQ-ACK feedback for PSSCHs 411 and 412 in PSFCH occasion 421, the Rx UE(s) may perform a channel access procedure in the gap symbol before PSFCH occasion 421.

In some examples, the Tx UE may determine to postpone the HARQ-ACK feedback for PSSCHs 413 and 414 when, for example, the Tx UE determines that the HARQ-ACK feedback for PSSCHs 413 and 414 cannot be transmitted within COT 451. The Tx UE may set the HARQ-ACK feedback timing indicators in the SCIs scheduling PSSCHs 413 and 414 to indicate an inapplicable value (e.g., a predefined inapplicable HARQ-ACK feedback timing value). In response to receiving the SCIs scheduling PSSCHs 413 and 414, the Rx UE(s) would know that the HARQ-ACK feedback for PSSCHs 413 and 414 is postponed based on the indicated inapplicable value, and may wait for a triggering signal requesting the transmission of the HARQ-ACK feedback for PSSCHs 413 and 414. In some examples, the Tx UE may initiate COT 452 and may transmit an SCI to trigger the transmission of the HARQ-ACK feedback for PSSCHs 413 and 414 in PFSCH occasion 422. The Tx UE may also transmit PSSCHs 415-418 in slots n+7 to n+10, respectively. The HARQ-ACK feedback for PSSCHs 415 and 416 may be transmitted inside of COT 452. The Tx UE may set the HARQ-ACK feedback timing indicators in the SCIs scheduling PSSCHs 415 and 416 to indicate PFSCH occasion 422. The Tx UE may leave a gap symbol before PSFCH occasion 422 blank such that the Rx UE(s) which receives PSSCHs 413-416 may perform a channel access procedure in the gap symbol before transmitting HARQ-ACK feedback in PFSCH occasion 422.

In some examples, the Tx UE may determine that the HARQ-ACK feedback for PSSCHs 417 and 418 cannot be transmitted within COT 452 and may indicate the HARQ-ACK feedback for PSSCHs 417 and 418 to be transmitted outside COT 452. For example, the Tx UE may set the HARQ-ACK feedback timing indicators in the SCIs scheduling PSSCHs 417 and 418 to indicate slot n+12 (e.g., PFSCH occasion 423). In response to receiving the SCIs scheduling PSSCHs 417 and 418, the Rx UE(s) would know that the HARQ-ACK feedback for PSSCHs 417 and 418 should be transmitted in slot n+12 (e.g., PFSCH occasion 423). In some examples, the Rx UE(s) may perform a channel access procedure in a gap symbol before PFSCH occasion 423 and may transmit the HARQ-ACK feedback for PSSCHs 417 and 418 in PFSCH occasion 423 in response to the channel access procedure being successful.

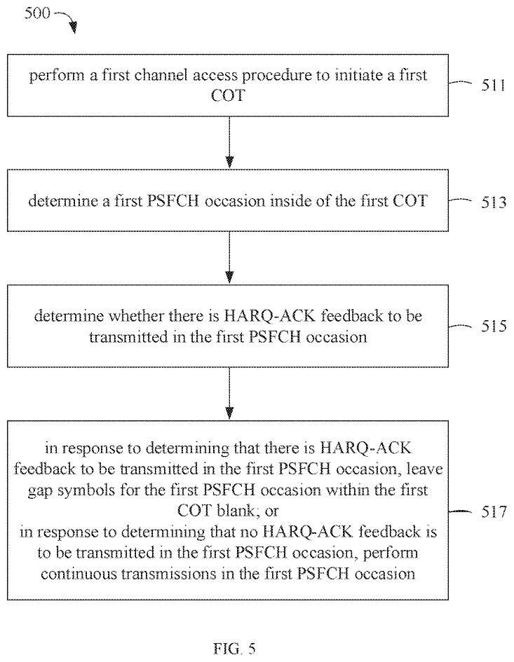

FIG. 5 illustrates a flow chart of exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a UE, for example, UE 110 in FIG. 1.

Referring to FIG. 5, in operation 511, a first UE may perform a first channel access procedure to initiate a first COT. For example, the first UE may be UE #1, UE #1A or UE #1B as described above. In operation 513, the first UE may determine a first PSFCH occasion inside of the first COT. In operation 515, the first UE may determine whether there is HARQ-ACK feedback to be transmitted in the first PSFCH occasion.

In operation 517, the first UE may leave gap symbols for the first PSFCH occasion within the first COT blank in response to determining that there is HARQ-ACK feedback to be transmitted in the first PSFCH occasion; or the first UE may perform continuous transmissions in the first PSFCH occasion in response to determining that no HARQ-ACK feedback is to be transmitted in the first PSFCH occasion.

In some embodiments of the present disclosure, the first PSFCH occasion is determined based on a PSFCH periodicity with reference to a PSFCH resource pool.

In some embodiments of the present disclosure, determining there is HARQ-ACK feedback to be transmitted in the first PSFCH occasion may include: determining first HARQ-ACK feedback for a first PSSCH is to be transmitted in the first PSFCH occasion, wherein the first PSSCH is transmitted by the first UE; determining second HARQ-ACK feedback for a second PSSCH is to be transmitted in the first PSFCH occasion, wherein the second PSSCH is received by the first UE; and determining third HARQ-ACK feedback for a third PSSCH is to be transmitted in the first PSFCH occasion, wherein the third PSSCH is not transmitted or received by the first UE.

In some embodiments of the present disclosure, the first UE may, in response to being incapable of determining whether there is HARQ-ACK feedback to be transmitted in the first PSFCH occasion, perform energy detection or a second channel access procedure in the first PSFCH occasion, and perform continuous transmissions in remaining duration of the first PSFCH occasion in response to the detected energy being lower than a threshold or the second channel access procedure being successful.

In some embodiments of the present disclosure, the first PSFCH occasion is determined based on a PSFCH periodicity with reference to the first COT.

In some embodiments of the present disclosure, the first UE may transmit a first PSSCH in the first COT to a second UE. The first UE may determine whether first HARQ-ACK feedback for the first PSSCH is to be transmitted in the first PSFCH occasion or outside of the first COT.

In some embodiments of the present disclosure, the first UE may, in response to determining that the first HARQ-ACK feedback for the first PSSCH is to be transmitted outside of the first COT, perform a third channel access procedure to initiate a second COT after the first COT, and transmit second SCI to request the second UE to transmit the first HARQ-ACK feedback in a second PSFCH occasion. The second PSFCH occasion is inside of the second COT and determined based on the PSFCH periodicity with reference to the second COT. In some embodiments of the present disclosure, the first UE may determine to cancel the first PSFCH occasion in response to determining that the first HARQ-ACK feedback for the first PSSCH is to be transmitted outside of the first COT

In some embodiments of the present disclosure, the first UE may perform continuous transmission in the first PSFCH occasion in response to determining to cancel the first PSFCH occasion.

In some embodiments of the present disclosure, the PSFCH periodicity is based on a CAPC used for performing the first channel access procedure. In some embodiments of the present disclosure, the PSFCH periodicity is based on a maximum duration of the first COT. In some embodiments of the present disclosure, the PSFCH periodicity is predefined or configured by RRC signaling.

In some embodiments of the present disclosure, the first UE may transmit, to a second UE, first SCI for scheduling a first PSSCH in the first COT. The first SCI includes a HARQ-ACK feedback timing indicator for the second UE to determine a PSFCH occasion for transmitting first HARQ-ACK feedback for the first PSSCH. the first UE may determine whether the first HARQ-ACK feedback is to be transmitted in the first PSFCH occasion or outside of the first COT.

In some embodiments of the present disclosure, the HARQ-ACK feedback timing indicator indicates an offset between a first slot where the first PSSCH is transmitted and a second slot where the first HARQ-ACK feedback for the first PSSCH is transmitted.

In some embodiments of the present disclosure, the HARQ-ACK feedback timing indicator indicates the offset from a set of HARQ-ACK feedback timing values.

In some embodiments of the present disclosure, the first SCI indicates a channel access type for the second UE to transmit the first HARQ-ACK feedback.

In some embodiments of the present disclosure, the first UE may, in response to determining that the first HARQ-ACK feedback for the first PSSCH is to be transmitted outside of the first COT, set the HARQ-ACK feedback timing indicator in the first SCI to indicate an inapplicable HARQ-ACK feedback timing value (e.g., −1) or a reserved code point, perform a third channel access procedure to initiate a second COT after the first COT, and transmit second SCI in the second COT to request the second UE to transmit the first HARQ-ACK feedback in a second PSFCH occasion. The second PSFCH occasion is inside of the second COT and determined based on a HARQ-ACK feedback timing value indicated by a HARQ-ACK feedback timing indicator in the second SCI.

In some embodiments of the present disclosure, the first UE may, in response to determining that the first HARQ-ACK feedback for the first PSSCH is to be transmitted outside of the first COT, set the HARQ-ACK feedback timing indicator in the first SCI to indicate a HARQ-ACK feedback timing value for indicating a third PSFCH occasion for transmitting the first HARQ-ACK feedback. The third PSFCH occasion is outside of the first COT.

In some embodiments of the present disclosure, the first UE may, in response to determining that the first HARQ-ACK feedback for the first PSSCH is to be transmitted in the first PSFCH occasion, set the HARQ-ACK feedback timing indicator in the first SCI to indicate a HARQ-ACK feedback timing value for indicating the first PSFCH occasion for transmitting the first HARQ-ACK feedback.

In some embodiments of the present disclosure, the second SCI schedules a PSSCH in the second COT, and includes a HARQ-ACK feedback request indicator requesting the transmission of the first HARQ-ACK feedback in the second COT.

In some embodiments of the present disclosure, the second SCI schedules a PSSCH in the second COT, and includes a first HARQ process number field and a HARQ-ACK feedback request indicator requesting a transmission of HARQ-ACK feedback associated with a HARQ process number(s) indicated by the first HARQ process number field in the second COT. The HARQ process number(s) indicated by the first HARQ process number field includes a HARQ process number associated with the first HARQ-ACK feedback.

In some embodiments of the present disclosure, the second SCI schedules a PSSCH in the second COT, and includes a second HARQ process number field for requesting a transmission of HARQ-ACK feedback for a previous PSSCH(s) associated with a HARQ process number(s) indicated by the second HARQ process number field in the second COT. The HARQ process number(s) indicated by the second HARQ process number field includes a HARQ process number associated with the first HARQ-ACK feedback.

In some embodiments of the present disclosure, the second SCI is specific for requesting HARQ-ACK feedback, and the second SCI includes a third HARQ process number field indicating a HARQ process number associated with the first HARQ-ACK feedback.

In some embodiments of the present disclosure, the first, second or third HARQ process number field further indicates at least one of: a HARQ process number associated with HARQ-ACK feedback which cannot be transmitted in the first COT due to a channel access process failure, or a HARQ process number associated with HARQ-ACK feedback which is not correctly received by the first UE in the first COT.

In some embodiments of the present disclosure, in the case that the second HARQ process number field indicates a HARQ process number the same as a fourth HARQ process number field in the second SCI associated with the PSSCH scheduled by the second SCI, the second HARQ process number field does not request a transmission of any HARQ-ACK feedback.

In some embodiments of the present disclosure, the first UE may receive the first HARQ-ACK feedback in the third PSFCH occasion. In some embodiments of the present disclosure, in response to not receiving the first HARQ-ACK feedback in the third PSFCH occasion, the first UE may perform a fourth channel access procedure to initiate a third COT after the third PSFCH occasion, and transmit third SCI in the third COT to request the second UE to transmit the first HARQ-ACK feedback in the third COT.

In some embodiments of the present disclosure, the first UE may determine whether the first HARQ-ACK feedback for the first PSSCH is disabled. The first UE may perform at least one of the following in response to determining that the first HARQ-ACK feedback for the first PSSCH is disabled: set the HARQ-ACK feedback timing indicator in the first SCI to indicate an inapplicable HARQ-ACK feedback timing value (e.g., −2) or a reserved code point; or set a HARQ enabling/disabling indicator in the first SCI to disable HARQ-ACK feedback for the first PSSCH.

It should be appreciated by persons skilled in the art that the sequence of the operations in exemplary procedure 500 may be changed and some of the operations in exemplary procedure 500 may be eliminated or modified, without departing from the spirit and scope of the disclosure.

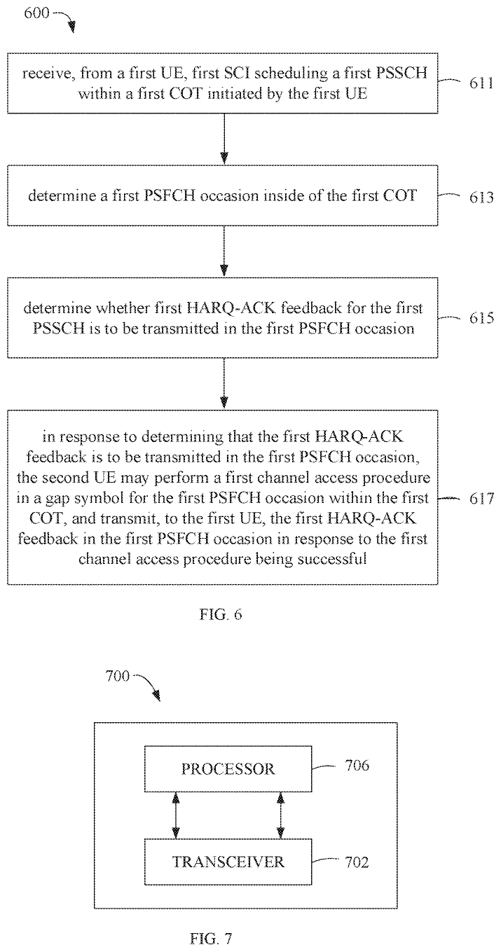

FIG. 6 illustrates a flow chart of exemplary procedure 600 for wireless communications in accordance with some embodiments of the present disclosure. Details described in all of the foregoing embodiments of the present disclosure are applicable for the embodiments shown in FIG. 6. In some examples, the procedure may be performed by a UE, for example, UE 110 in FIG. 1.

Referring to FIG. 6, in operation 611, a second UE may receive, from a first UE, first SCI scheduling a first PSSCH within a first COT initiated by the first UE. For example, the first UE may be UE #1, UE #1A or UE #1B as described above. The second UE may be UE #2, UE #2A or UE #2B as described above.

In operation 613, the second UE may determine a first PSFCH occasion inside of the first COT. In operation 615, the second UE may determine whether first HARQ-ACK feedback for the first PSSCH is to be transmitted in the first PSFCH occasion.

In operation 617, in response to determining that the first HARQ-ACK feedback is to be transmitted in the first PSFCH occasion, the second UE may perform a first channel access procedure in a gap symbol for the first PSFCH occasion within the first COT, and transmit, to the first UE, the first HARQ-ACK feedback in the first PSFCH occasion in response to the first channel access procedure being successful.

In some embodiments of the present disclosure, the first PSFCH occasion is determined based on a PSFCH periodicity with reference to a PSFCH resource pool.

In some embodiments of the present disclosure, the first PSFCH occasion is determined based on a PSFCH periodicity with reference to the first COT.

In some embodiments of the present disclosure, in response to determining that the first HARQ-ACK feedback for the first PSSCH is to be transmitted outside of the first COT, the second UE may postpone a transmission of the first HARQ-ACK feedback until receiving, from the first UE, a second SCI in a second COT initiated by the first UE for requesting the transmission of the first HARQ-ACK feedback in a second PSFCH occasion. The second PSFCH occasion is inside of the second COT and determined based on the PSFCH periodicity with reference to the second COT.

In some embodiments of the present disclosure, the PSFCH periodicity is based on a CAPC used for performing a channel access procedure to initiate the first COT. In some embodiments of the present disclosure, the PSFCH periodicity is based on a maximum duration of the first COT. In some embodiments of the present disclosure, the PSFCH periodicity is predefined or configured by RRC signaling.

In some embodiments of the present disclosure, the first SCI includes a HARQ-ACK feedback timing indicator for the second UE to determine a PSFCH occasion for transmitting the first HARQ-ACK feedback for the first PSSCH.

In some embodiments of the present disclosure, the HARQ-ACK feedback timing indicator indicates an offset between a first slot where the first PSSCH is transmitted and a second slot where the first HARQ-ACK feedback for the first PSSCH is transmitted.

In some embodiments of the present disclosure, the HARQ-ACK feedback timing indicator indicates the offset from a set of HARQ-ACK feedback timing values.

In some embodiments of the present disclosure, the first SCI indicates a channel access type for the second UE to transmit the first HARQ-ACK feedback.

In some embodiments of the present disclosure, in the case that the HARQ-ACK feedback timing indicator in the first SCI indicates an inapplicable HARQ-ACK feedback timing value (e.g.,-1) or a reserved code point, the second UE may postpone a transmission of the first HARQ-ACK feedback until receiving, from the first UE, a second SCI in a second COT initiated by the first UE for requesting the transmission of the first HARQ-ACK feedback in a second PSFCH occasion. The second PSFCH occasion is inside of the second COT and determined based on a HARQ-ACK feedback timing value indicated by a HARQ-ACK feedback timing indicator in the second SCI.

In some embodiments of the present disclosure, in the case that the HARQ-ACK feedback timing indicator in the first SCI indicates an applicable HARQ-ACK feedback timing value indicating a third PSFCH occasion outside of the first COT for transmitting the first HARQ-ACK feedback, the second UE may transmit the first HARQ-ACK feedback in the third PSFCH occasion.

In some embodiments of the present disclosure, in the case that the HARQ-ACK feedback timing indicator in the first SCI indicates an applicable HARQ-ACK feedback timing value indicating the first PSFCH occasion for transmitting the first HARQ-ACK feedback, the second UE may transmit the first HARQ-ACK feedback in the first PSFCH occasion.

In some embodiments of the present disclosure, the second SCI schedules a PSSCH in the second COT, and includes a HARQ-ACK feedback request indicator requesting the transmission of the first HARQ-ACK feedback in the second COT.

In some embodiments of the present disclosure, the second SCI schedules a PSSCH in the second COT, and includes a first HARQ process number field and a HARQ-ACK feedback request indicator requesting a transmission of HARQ-ACK feedback associated with a HARQ process number(s) indicated by the first HARQ process number field in the second COT. The HARQ process number(s) indicated by the first HARQ process number field includes a HARQ process number associated with the first HARQ-ACK feedback.

In some embodiments of the present disclosure, the second SCI schedules a PSSCH in the second COT, and includes a second HARQ process number field for requesting a transmission of HARQ-ACK feedback for a previous PSSCH(s) associated with a HARQ process number(s) indicated by the second HARQ process number field in the second COT. The HARQ process number(s) indicated by the second HARQ process number field includes a HARQ process number associated with the first HARQ-ACK feedback.

In some embodiments of the present disclosure, the second SCI is specific for requesting HARQ-ACK feedback, and the second SCI includes a third HARQ process number field indicating a HARQ process number associated with the first HARQ-ACK feedback.

In some embodiments of the present disclosure, the first, second or third HARQ process number field further indicates at least one of: a HARQ process number associated with HARQ-ACK feedback which cannot be transmitted in the first COT due to a channel access process failure, or a HARQ process number associated with HARQ-ACK feedback which is not correctly received by the first UE in the first COT.

In some embodiments of the present disclosure, in the case that the second HARQ process number field indicates a HARQ process number the same as a fourth HARQ process number field in the second SCI associated with the PSSCH scheduled by the second SCI, the second HARQ process number field does not request a transmission of any HARQ-ACK feedback.

In some embodiments of the present disclosure, the second UE may perform a second channel access procedure for transmitting the first HARQ-ACK feedback in the third PSFCH occasion. In response to the second channel access procedure being successful, the second UE may transmit the first HARQ-ACK feedback in the third PSFCH occasion. In response to the second channel access procedure being unsuccessful, the second UE may drop the third PSFCH occasion.

In some embodiments of the present disclosure, in response to the second channel access procedure being unsuccessful, the second UE may receive, from the first UE, a third SCI in a third COT initiated by the first UE for requesting the transmission of the first HARQ-ACK feedback in the third COT.

In some embodiments of the present disclosure, in the case that the first HARQ-ACK feedback for the first PSSCH is disabled, the HARQ-ACK feedback timing indicator in the first SCI indicates an inapplicable HARQ-ACK feedback timing value (e.g., −2) or a reserved code point. In some embodiments of the present disclosure, in the case that the first HARQ-ACK feedback for the first PSSCH is disabled, a HARQ enabling/disabling indicator in the first SCI indicates that HARQ-ACK feedback for the first PSSCH is disabled.

It should be appreciated by persons skilled in the art that the sequence of the operations in exemplary procedure 600 may be changed and some of the operations in exemplary procedure 600 may be eliminated or modified, without departing from the spirit and scope of the disclosure.

FIG. 7 illustrates a block diagram of an exemplary apparatus 700 according to some embodiments of the present disclosure. As shown in FIG. 7, the apparatus 700 may include at least one processor 706 and at least one transceiver 702 coupled to the processor 706. The apparatus 700 may be a UE.

Although in this figure, elements such as the at least one transceiver 702 and processor 706 are described in the singular, the plural is contemplated unless a limitation to the singular is explicitly stated. In some embodiments of the present application, the transceiver 702 may be divided into two devices, such as a receiving circuitry and a transmitting circuitry. In some embodiments of the present application, the apparatus 700 may further include an input device, a memory, and/or other components.

In some embodiments of the present application, the apparatus 700 may be a UE. The transceiver 702 and the processor 706 may interact with each other so as to perform the operations with respect to the UE described in FIGS. 1-6.

In some embodiments of the present application, the apparatus 700 may further include at least one non-transitory computer-readable medium. For example, in some embodiments of the present disclosure, the non-transitory computer-readable medium may have stored thereon computer-executable instructions to cause the processor 706 to implement the method with respect to the UE as described above. For example, the computer-executable instructions, when executed, cause the processor 706 interacting with transceiver 702 to perform the operations with respect to the UE described in FIGS. 1-6.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including.” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A. B. or both A and B. The wording “the first,” “the second” or the like is only used to clearly illustrate the embodiments of the present application, but is not used to limit the substance of the present application.

What is claimed is:

1. A first user equipment (UE) for wireless communication, comprising:
at least one memory; and
at least one processor coupled with the at least one memory and configured to cause the first UE to:
perform a first channel access procedure to initiate a first channel occupancy time (COT);
determine a first physical sidelink feedback channel (PSFCH) occasion inside of the first COT;
determine whether there is hybrid automatic repeat request acknowledgement (HARQ-ACK) feedback to be transmitted in the first PSFCH occasion; and
in response to determining that there is HARQ-ACK feedback to be transmitted in the first PSFCH occasion, leave gap symbols for the first PSFCH occasion within the first COT blank; or
in response to determining that no HARQ-ACK feedback is to be transmitted in the first PSFCH occasion, perform continuous transmissions in the first PSFCH occasion.

2. The first UE of claim 1, wherein determining that there is HARQ-ACK feedback to be transmitted in the first PSFCH occasion comprises:
determining that first HARQ-ACK feedback for a first physical sidelink shared channel (PSSCH) is to be transmitted in the first PSFCH occasion, wherein the first PSSCH is transmitted by the first UE;
determining that second HARQ-ACK feedback for a second PSSCH is to be transmitted in the first PSFCH occasion, wherein the second PSSCH is received by the first UE; and
determining that third HARQ-ACK feedback for a third PSSCH is to be transmitted in the first PSFCH occasion, wherein the third PSSCH is not transmitted or received by the first UE.

3. The first UE of claim 1, wherein the at least one processor is further configured to cause the first UE to:
in response to being unable to determine whether there is HARQ-ACK feedback to be transmitted in the first PSFCH occasion:
perform energy detection or a second channel access procedure in the first PSFCH occasion; and
perform continuous transmissions in a remaining duration of the first PSFCH occasion in response to the detected energy being lower than a threshold or the second channel access procedure being successful.

4. The first UE of claim 1, wherein the first PSFCH occasion is determined based on a PSFCH periodicity with reference to the first COT.

5. The first UE of claim 4, wherein the at least one processor is further configured to cause the first UE to:
transmit a first physical sidelink shared channel (PSSCH) in the first COT to a second UE; and
determine whether first HARQ-ACK feedback for the first PSSCH is to be transmitted in the first PSFCH occasion or outside of the first COT.

6. The first UE of claim 5, wherein the at least one processor is further configured to cause the first UE to, in response to determining that the first HARQ-ACK feedback for the first PSSCH is to be transmitted outside of the first COT:
perform a third channel access procedure to initiate a second COT after the first COT; and
transmit second sidelink control information (SCI) to request the second UE to transmit the first HARQ-ACK feedback in a second PSFCH occasion, wherein the second PSFCH occasion is inside of the second COT and determined based on the PSFCH periodicity with reference to the second COT; or
determine to cancel the first PSFCH occasion.

7. The first UE of claim 1, wherein the at least one processor is configured to cause the first UE to:
transmit, to a second UE, first sidelink control information (SCI) for scheduling a first physical sidelink shared channel (PSSCH) in the first COT, wherein the first SCI includes a HARQ-ACK feedback timing indicator for the second UE to determine a PSFCH occasion for transmitting first HARQ-ACK feedback for the first PSSCH; and
determine whether the first HARQ-ACK feedback is to be transmitted in the first PSFCH occasion or outside of the first COT.

8. The first UE of claim 7, wherein the first SCI indicates a channel access type for the second UE to transmit the first HARQ-ACK feedback.

9. The first UE of claim 7, wherein the at least one processor is configured to cause the first UE to, in response to determining that the first HARQ-ACK feedback for the first PSSCH is to be transmitted outside of the first COT:
set the HARQ-ACK feedback timing indicator in the first SCI to indicate an inapplicable HARQ-ACK feedback timing value or a reserved code point; and
perform a third channel access procedure to initiate a second COT after the first COT; and one or more of:
transmit second SCI in the second COT to request the second UE to transmit the first HARQ-ACK feedback in a second PSFCH occasion, wherein the second PSFCH occasion is inside of the second COT and determined based on a HARQ-ACK feedback timing value indicated by a HARQ-ACK feedback timing indicator in the second SCI; or
set the HARQ-ACK feedback timing indicator in the first SCI to indicate a HARQ-ACK feedback timing value for indicating a third PSFCH occasion for transmitting the first HARQ-ACK feedback, wherein the third PSFCH occasion is outside of the first COT; or
wherein the at least one processor is configured to cause the first UE to, in response to determining that the first HARQ-ACK feedback for the first PSSCH is to be transmitted in the first PSFCH occasion, set the HARQ-ACK feedback timing indicator in the first SCI to indicate a HARQ-ACK feedback timing value for indicating the first PSFCH occasion for transmitting the first HARQ-ACK feedback.

10. The first UE of claim 6, wherein one or more of:
the second SCI schedules a PSSCH in the second COT, and includes a HARQ-ACK feedback request indicator requesting the transmission of the first HARQ-ACK feedback in the second COT;
the second SCI schedules a PSSCH in the second COT, and includes a first HARQ process number field and a HARQ-ACK feedback request indicator requesting a transmission of HARQ-ACK feedback associated with a HARQ process number(s) indicated by the first HARQ process number field in the second COT, and wherein the HARQ process number(s) indicated by the first HARQ process number field includes a HARQ process number associated with the first HARQ-ACK feedback;
the second SCI schedules a PSSCH in the second COT, and includes a second HARQ process number field for requesting a transmission of HARQ-ACK feedback for a previous PSSCH(s) associated with a HARQ process number(s) indicated by the second HARQ process number field in the second COT, and wherein the HARQ process number(s) indicated by the second HARQ process number field includes a HARQ process number associated with the first HARQ-ACK feedback; or
the second SCI is specific for requesting HARQ-ACK feedback, and the second SCI includes a third HARQ process number field indicating a HARQ process number associated with the first HARQ-ACK feedback.

11. The first UE of claim 10, wherein one or more of the first HARQ process number field, the second HARQ process number field, or the third HARQ process number field further indicates at least one of: a HARQ process number associated with HARQ-ACK feedback which cannot be transmitted in the first COT due to a channel access process failure, or a HARQ process number associated with HARQ-ACK feedback which is not correctly received by the first UE in the first COT.

12. The first UE of claim 9, wherein the at least one processor is configured to cause the first UE to:
receive the first HARQ-ACK feedback in the third PSFCH occasion; or
in response to not receiving the first HARQ-ACK feedback in the third PSFCH occasion:
perform a fourth channel access procedure to initiate a third COT after the third PSFCH occasion; and
transmit third SCI in the third COT to request the second UE to transmit the first HARQ-ACK feedback in the third COT.

13. The first UE of claim 7, wherein the at least one processor is configured to cause the first UE to:
determine whether the first HARQ-ACK feedback for the first PSSCH is disabled; and
in response to determining that the first HARQ-ACK feedback for the first PSSCH is disabled, at least one of:
set the HARQ-ACK feedback timing indicator in the first SCI to indicate an inapplicable HARQ-ACK feedback timing value or a reserved code point; or
set a HARQ enabling/disabling indicator in the first SCI to disable HARQ-ACK feedback for the first PSSCH.

14. A second user equipment (UE) for wireless communication, comprising:
at least one memory; and
at least one processor coupled with the at least one memory and configured to cause the second UE to:
receive, from a first UE, first sidelink control information (SCI) scheduling a first physical sidelink shared channel (PSSCH) within a first channel occupancy time (COT) initiated by the first UE;
determine a first physical sidelink feedback channel (PSFCH) occasion inside of the first COT;
determine whether first hybrid automatic repeat request acknowledgement (HARQ-ACK) feedback for the first PSSCH is to be transmitted in the first PSFCH occasion; and
in response to determining that the first HARQ-ACK feedback is to be transmitted in the first PSFCH occasion:
perform a first channel access procedure in a gap symbol for the first PSFCH occasion within the first COT; and
transmit, to the first UE, the first HARQ-ACK feedback in the first PSFCH occasion in response to the first channel access procedure being successful.

15. A method performed by a first user equipment (UE), the method comprising:
performing a first channel access procedure to initiate a first channel occupancy time (COT);
determining a first physical sidelink feedback channel (PSFCH) occasion inside of the first COT;
determining whether there is hybrid automatic repeat request acknowledgement (HARQ-ACK) feedback to be transmitted in the first PSFCH occasion; and
in response to determining that there is HARQ-ACK feedback to be transmitted in the first PSFCH occasion, leaving gap symbols for the first PSFCH occasion within the first COT blank; or
in response to determining that no HARQ-ACK feedback is to be transmitted in the first PSFCH occasion, performing continuous transmissions in the first PSFCH occasion.

16. A processor for wireless communication, comprising:
at least one controller coupled with at least one memory and configured to cause the processor to:
perform a first channel access procedure to initiate a first channel occupancy time (COT);
determine a first physical sidelink feedback channel (PSFCH) occasion inside of the first COT;
determine whether there is hybrid automatic repeat request acknowledgement (HARQ-ACK) feedback to be transmitted in the first PSFCH occasion; and
in response to determining that there is HARQ-ACK feedback to be transmitted in the first PSFCH occasion, leave gap symbols for the first PSFCH occasion within the first COT blank; or
in response to determining that no HARQ-ACK feedback is to be transmitted in the first PSFCH occasion, perform continuous transmissions in the first PSFCH occasion.

17. The processor of claim 16, wherein determining that there is HARQ-ACK feedback to be transmitted in the first PSFCH occasion comprises:
determining that first HARQ-ACK feedback for a first physical sidelink shared channel (PSSCH) is to be transmitted in the first PSFCH occasion, wherein the first PSSCH is transmitted by a first user equipment (UE);
determining that second HARQ-ACK feedback for a second PSSCH is to be transmitted in the first PSFCH occasion, wherein the second PSSCH is received by the first UE; and
determining that third HARQ-ACK feedback for a third PSSCH is to be transmitted in the first PSFCH occasion, wherein the third PSSCH is not transmitted or received by the first UE.

18. The processor of claim 16, wherein the at least one controller is further configured to cause the processor to:
in response to being unable to determine whether there is HARQ-ACK feedback to be transmitted in the first PSFCH occasion:
perform energy detection or a second channel access procedure in the first PSFCH occasion; and
perform continuous transmissions in a remaining duration of the first PSFCH occasion in response to the detected energy being lower than a threshold or the second channel access procedure being successful.

19. The processor of claim 16, wherein the first PSFCH occasion is determined based on a PSFCH periodicity with reference to the first COT.

20. The processor of claim 19, wherein the at least one controller is further configured to cause the processor to:
transmit a first physical sidelink shared channel (PSSCH) in the first COT to a second UE; and
determine whether first HARQ-ACK feedback for the first PSSCH is to be transmitted in the first PSFCH occasion or outside of the first COT.
